(19) United States
(12) Patent Application Publication
(10) Pub. No.: US 2026/0292136 A1
(43) Pub. Date: Sep. 24, 2026

(54) INTER-CHROMA WITH CROSS-TYPE REFERENCING AND CONSTRAINED REFERENCE REGION

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW)

(21) Appl. No.: 19/472,065

(22) PCT Filed: Jul. 12, 2024
(86) PCT No.: PCT/CN2024/105154

§ 371 Date: Oct. 2, 2025

Related U.S. Application Data
(60) Provisional application No. 63/513,366, filed on Jul. 13, 2023.

(51) Int. Cl. H04N 19/105; H04N 19/159; H04N 19/176; H04N 19/196

(52) U.S. Cl. CPC H04N 19/105; H04N 19/159; H04N 19/176; H04N 19/196

(57) ABSTRACT

A method for using cross-component prediction for video coding is provided. A video coder receives data to be encoded or decoded as a current block of pixels of a current picture of a video. The video coder identifies a predefined region that is applicable to the current block. The video coder derives a list of candidates that can be inherited by the current block, the list comprising cross-component prediction models from positions outside the predefined region. The video coder selects one or more cross-component models from the list of candidates. The video coder encodes or decodes the current block by applying the selected one or more cross-component models to reconstructed or predicted first component of the current block to generate a predictor for a second component of the current block.

### CROSS REFERENCE TO RELATED PATENT APPLICATION(S)

The present disclosure is part of a non-provisional application that claims the priority benefit of U.S. Provisional Patent Application No. 63/513,366 filed on 13 Jul. 2023. Content of above-listed application is herein incorporated by reference.

### TECHNICAL FIELD

The present disclosure relates generally to video coding. In particular, the present disclosure relates to methods of coding pixel blocks by cross-component prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU. (The term “block” in this disclosure may refer to TU/TB, CU/CB, PU/PB, or CTU/CTB.)

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for using cross-component prediction for video coding is provided. A video coder receives data to be encoded or decoded as a current block of pixels of a current picture of a video. The video coder identifies a predefined region that is applicable to the current block. The video coder derives a list of candidates that can be inherited by the current block, the list comprising cross-component prediction models from positions outside the predefined region. The video coder selects one or more cross-component models from the list of candidates. The video coder encodes or decodes the current block by applying the selected one or more cross-component models to reconstructed or predicted first component of the current block to generate a predictor for a second component of the current block. The video coder may generate a cross component prediction by applying the selected one or more cross-component models to a reconstructed or predicted first component (e.g., luma Y or chroma Cb) of the current block to generate a predictor for a second component (e.g., chroma Cb or chroma Cr) of the current block. The current block may be inter-predicted or IBC-predicted.

The predefined region may encompass the current block and another block that also uses the same list of candidates (or part thereof) for cross-component prediction. The another block may use at least one of spatial adjacent, spatial non-adjacent and history candidates from the list of candidates of the current block. The predefined region may encompass first and second blocks, wherein a first candidate list derived for the first block excludes cross-component prediction information or model from the second block and a second candidate list derived for the second block excludes cross-component prediction information or model from the first block. Hence, the first candidate list and the second candidate list are independently derived. In some embodiments, a history-based model candidate list is updated only if a size of the current block is larger than a threshold that is determined based on a size of the predefined region.

In some embodiments, a subsequent coded block that is coded by a different prediction mode than the current block is allowed to inherit the selected cross-component model, such that an intra coded subsequent clock may inherit the cross-component model from an inter coded block. In some embodiments, a subsequent coded block that is coded by a different prediction mode than the current block is not allowed to inherit the selected cross-component model.

In some embodiments, the video coder identifies a representative prediction mode for the current block and using the representative prediction mode to select at least one of a transform set (primary and secondary) and a transpose flag for transforming or inverse transforming the prediction residuals of the current block, where the current block is a chroma block. In some embodiments, the representative prediction mode is identified by performing texture gradient analysis of the predicted chroma samples (or subsampling of the predicted chroma samples) of the current block, where the current block is a chroma block. In some embodiments, the representative prediction mode is used if the current chroma block is referenced when deriving a set of most probable modes (MPM) for intra coding a subsequent block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows template and reference samples used for Template-based intra mode derivation (TIMD).

FIG. 2 illustrates the positions of spatial merge candidates.

FIG. 3 shows spatial neighboring blocks used to derive the spatial merge candidates.

FIG. 4 illustrates motion vector scaling for temporal merge candidate.

FIG. 5 shows candidate positions for temporal merge candidate.

FIG. 6 conceptually illustrates a merge list for blocks in a same merge estimation region (MER).

FIGS. 7A-B depicts Region-Of-Interest (ROI) for Low Frequency Non-Separable Transform (LFNST).

FIG. 8 shows the mapping from intra prediction modes to LFNST set indices.

FIG. 9 illustrates reconstruction of component samples using cross-component residual model (CCRM).

FIG. 10 conceptually illustrates inheriting temporal neighboring model parameters.

FIGS. 11A-B illustrate non-adjacent spatial neighboring blocks from which model parameters may be inherited.

FIG. 12 conceptually illustrates model lists for blocks in a same cross-component merge estimation region (CCMER).

FIG. 13 illustrates an example video encoder that may implement cross component prediction.

FIG. 14 illustrates portions of the video encoder that implement various features of cross-component prediction.

FIG. 15 conceptually illustrates a process for using cross-component prediction to encode a pixel block.

FIG. 16 illustrates an example video decoder that may implement cross component prediction.

FIG. 17 illustrates portions of the video decoder that implement various features of cross-component prediction.

FIG. 18 conceptually illustrates a process for using cross-component prediction to decode a pixel block.

FIG. 19 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

a. Directional Intra Modes

Intra-prediction method exploits one or more reference lines adjacent to the current prediction unit (PU) and one of the intra-prediction modes to generate the predictors for the current PU. The Intra-prediction direction can be chosen among a mode set containing multiple prediction directions, DC mode, and Planar mode. The intra prediction mode may also refer to any intra mode which determines the predictor of the current block using the spatially reconstructed samples. The number of directional intra modes may be 33 or extended to 65 direction modes. By including DC and Planar modes, the number of intra-prediction mode is 35 (or 67). Some intra-prediction modes (e.g., 3 or 5) are identified as a set of most probable modes (MPM) for intra-prediction in current prediction block so an index may be signaled to select one of the MPMs.

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

When referring intra prediction, the terms “angular” and “directional” are used interchangeably in this disclosure. For example, the terms {angular mode, angular intra prediction, angular intra mode} and {directional mode, directional intra prediction, directional intra mode} are used interchangeably.

b. Decoder Side Intra Mode Derivation (DIMD)

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

c. Template-Based Intra Mode Derivation (TIMD)

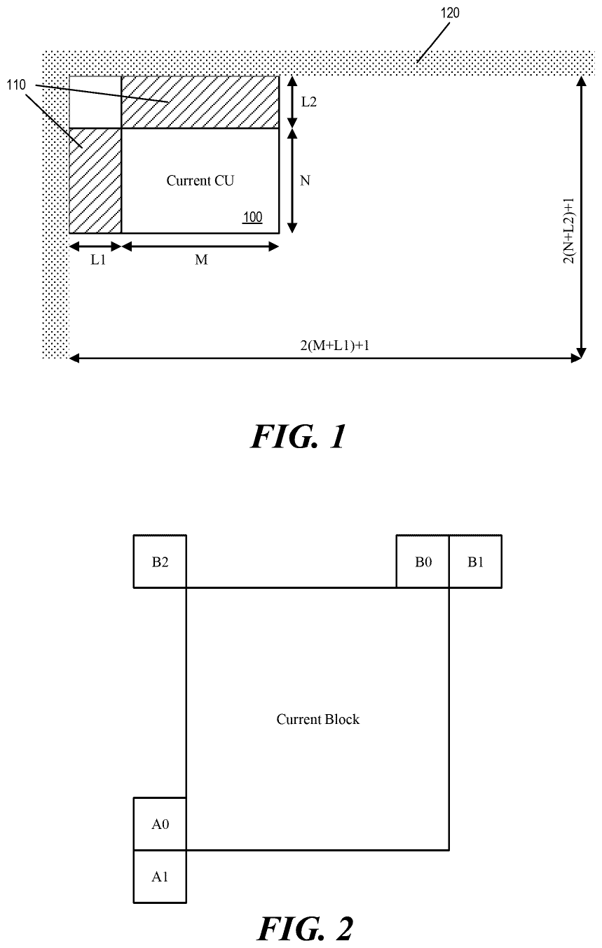

Template-based intra mode derivation (TIMD) mode implicitly derives the intra prediction mode of a CU using a neighboring template at both encoder and decoder, instead of signalling exact intra prediction mode bits to the decoder. FIG. 1 shows template and reference samples used for TIMD. As illustrated, the prediction samples of the template 110 are generated using the reference samples 120 of the template for each candidate mode. A cost is calculated as the SATD between the prediction and the reconstruction samples of the template. The intra prediction mode with the minimum cost is selected as the TIMD mode and used for intra prediction of the CU 100. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list.

d. Intra Template Matching (IntraTMP)

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### II. Inter Prediction

For each inter-predicted CU, motion parameters including motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.
A number of inter prediction coding tools listed as followed:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)
   a. Extended Merge Prediction

The merge candidate list may be constructed by including the following five types of candidates in order:
Spatial MVP from spatial neighbour CUs (Spatial Merge Candidates)
Temporal MVP from collocated CUs (Temporal Merge Candidates)
History-based MVP from a FIFO table (HMVP Merge Candidate)
Pairwise average MVP (Pairwise Merge Candidate)
Zero MVs.

FIG. 2 illustrates the positions of spatial merge candidates. A maximum of four merge candidates are selected among candidates located in the positions depicted in the figure. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₀ is added, the addition of the remaining candidates is subject to a redundancy check which ensures that candidates with same motion information are excluded from the list so that coding efficiency is improved.

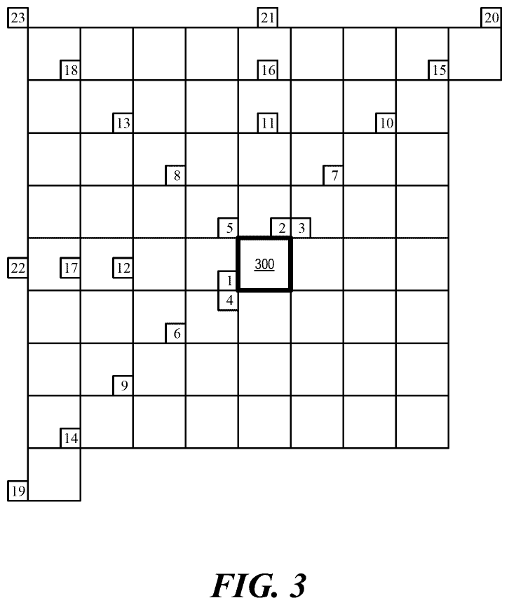

In addition to the above-mentioned spatial candidates, the non-adjacent spatial merge candidates are inserted after the TMVP in the regular merge candidate list. FIG. 3 shows spatial neighboring blocks used to derive the spatial merge candidates. The distances between non-adjacent spatial candidates and current coding block are based on the width and height of current coding block. The line buffer restriction is not applied.

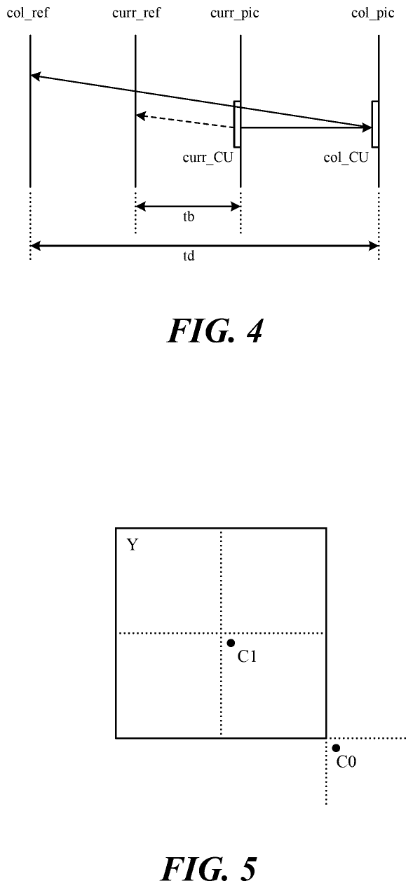

For temporal merge candidate, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signaled in the slice header. FIG. 4 illustrates motion vector scaling for temporal merge candidate. The scaled motion vector is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

FIG. 5 shows candidate positions for temporal merge candidate. As illustrated, the position for the temporal candidate is selected between candidates C₀ and C₁. If CU at position C₀ is not available, is intra coded, or is outside of the current row of CTUs, position C₁ is used. Otherwise, position C₀ is used in the derivation of the temporal merge candidate.

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

Pairwise average candidates are generated by averaging predefined pairs of candidates in the existing merge candidate list, using the first two merge candidates. The first merge candidate is defined as p0Cand and the second merge candidate id defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

b. Merge Estimation Region (MER)

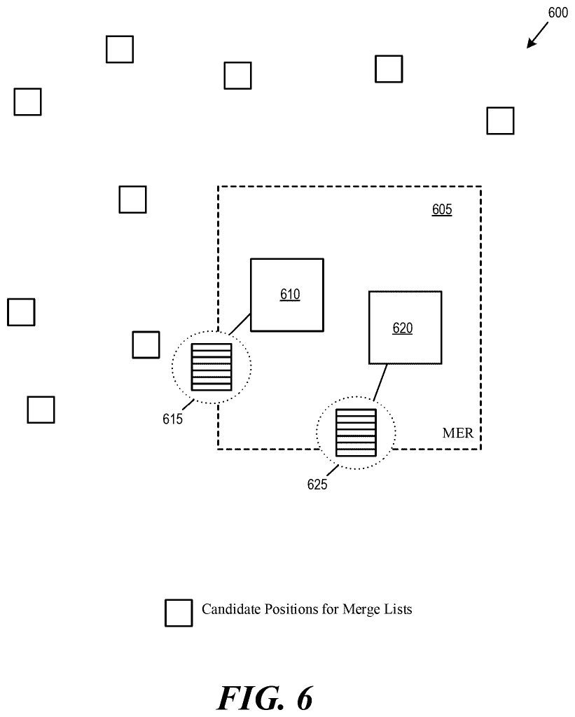

Merge estimation region (MER) allows independent derivation of merge candidate list for the CUs in the same merge estimation region (MER). A candidate block that is within the same MER to the current CU is not included for the generation of the merge candidate list of the current CU. FIG. 6 conceptually illustrates a merge list for blocks in a same merge estimation region (MER). The figure illustrates a MER 605 in a picture 600. Block 610 is in the MER 605 and uses a merge candidate list 615. Block 620 is also in the MER 605 and uses a merge candidate list 625. Both merge list 615 and the merge list 625 are derived based on candidate positions outside of MER 605.

In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is greater than (yCb>>Log2ParMrgLevel) and where (xCb, yCb) is the top-left luma sample position of the current CU in the picture and (cbWidth, cbHeight) is the CU size. The MER size is selected at encoder side and signaled as log2_parallel_merge_level_minus2 (i.e., Log2ParMrgLevel−2) in the sequence parameter set.

### III. Multi Transform Selection (MTS)

Multi Transform Selection (MTS) is a variant of cosine transform that was added in VVC. In its predecessor HEVC, DCT-II was the only variant of this type. In comparison with HEVC, MTS has some new sine/cosine transform types: DST-7 and DCT-8. In the current VVC design, for MTS, only DST7 and DCT8 transform kernels are utilized which are used for intra and inter coding. Additional primary transforms including DCT5, DST4, DST1, and identity transform (IDT) are employed.

a. MTS for Intra Coding

MTS set is made dependent on the TU size and intra mode information. For blocks predicted via IntraTMP, DIMD process is used on the predition block to derive an intra mode that is used for transform selection. Specifically, a horizontal gradient and a vertical gradient are calculated for each predicted sample to build a HoG. Then the intra prediction mode with the largest histogram amplitude values is used to select the MTS transform set.

Overall, 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0
4 candidates: th0<sum<=th1
6 candidates: sum>th1

Note, although a total of 80 different classes are considered, some of those different classes often share exactly same transform set. So there are 58 (less than 80) unique entries in the resultant LUT.

For angular intra prediction modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

b. MTS for Inter Coding

For the MTS of inter-coded CUs, four candidates: {(DST7, DST7), (DST7, DCT8), (DCT8, DST7), (DCT8, DCT8)} are used for every CU. For the larger resolution sequences (width>1080) maximum CU size for Inter-MTS usage is set to 32 (i.e., Inter-MTS is used for CU with width<=32 and height<=32), and for the remaining sequences (smaller resolution) it is set to 16. For 4-pt, 8-pt and 16-pt transforms, the current AMT transform cores, i.e., DST-7 and DCT-8, is replaced with separable KLTs.

c. Low Frequency Non-Separable Transform (LFNST)

Low Frequency Non-Separable Transform (LFNST) is a secondary transform that is applied between forward primary transform and quantization (on the encoder side) and between de-quantization and inverse primary transform (on the decoder side).

LFNST is a direct matrix multiplication that transforms coefficients from the DCT-II transform. The main goal of LFNST is to further compress the redundancy between low-frequency primary transform coefficients, which are transform coefficients from the conventional direction intra prediction. In some embodiments, LFNST applies only for intra blocks for both luma and chroma components.

For some embodiments, the LFNST design is extended as follows. The number of LFNST sets(S) and candidates (C) are extended to S=35 and C=3, and the LFNST set (lfnstTrSetIdx) for a given intra mode (predModeIntra) is derived according to the following formula:
For predModeIntra<2, lfnstTrSetIdx is equal to 2
lfnstTrSetIdx=predModeIntra, for predModeIntra in [0,34]
lfnstTrSetIdx=68−predModeIntra, for predModeIntra in [35,66]

Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively. The kernel dimensions are specified by:

$$( LFNST4 * , LFNST8 \text{*)} = ( 16 \times 16 , 32 \times 64 , 32 \times 96 )$$

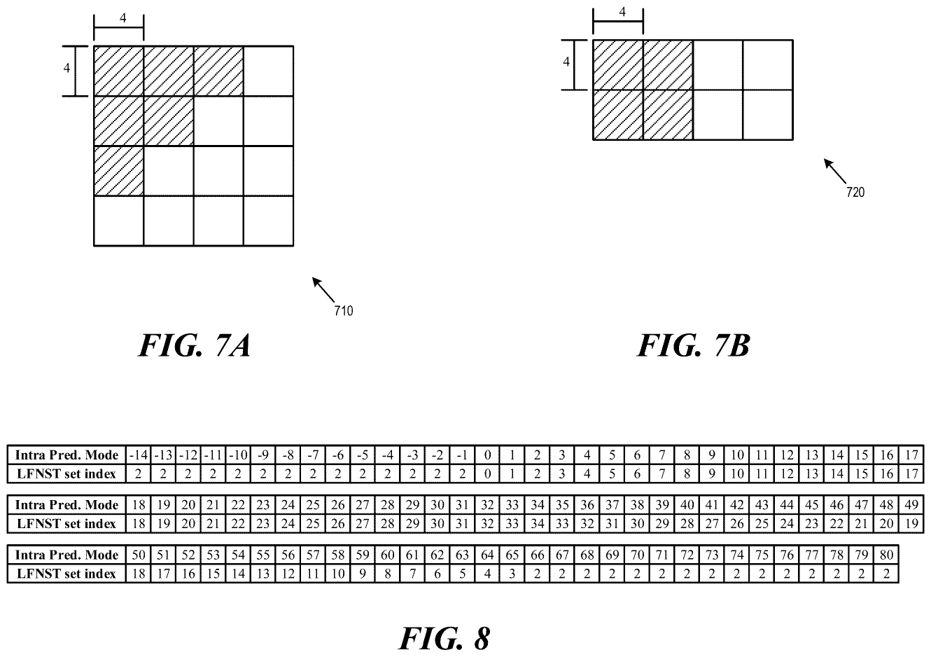

The forward LFNST is applied to top-left low frequency region, which is called Region-Of-Interest (ROI). When LFNST is applied, primary-transformed coefficients that exist in the region other than ROI are zeroed out. FIG. 7A depicts the Region-Of-Interest (ROI) for LFNST16 for a block 710. The ROI consists of six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order. FIG. 7B depicts the Region-Of-Interest (ROI) for LFNST8 for a block 720. The forward LFNST8 matrix can be R×64 and R is chosen to be 32. The generated coefficients are located in the same manner as with LFNST16. FIG. 8 shows the mapping from intra prediction modes to LFNST set indices.

d. Non-Separable Primary Transform (NSPT) for Intra Coding

The separable DCT-II plus LFNST transform combinations may be replaced with NSPT for the block shapes 4×4, 4×8, 8×4 and 8×8, 4×16, 16×4, 8×16 and 16×8. The affected block sizes are summarized in Table 1

TABLE 1

| | Block Size | | | | | |
|---|---|---|---|---|---|---|
| | 4 × N/N × 4 ≥ 4 | | | | | |
| | 4 × 4 | 4 × 8 | 8 × 4 | 4 × 16 | 16 × 4 | else |
| Transform | NSPT4 × 4 | NSPT4 × 8 | NSPT8 × 4 | NSPT4 × 16 | NSPT16 × 4 | DCT-II + |
| | | | | | | LFNST4 |

| | Block Size | | | | |
|---|---|---|---|---|---|
| | 8 × N/N × 8 ≥ 8 | | | | M × N |
| | 8 × 8 | 8 × 16 | 16 × 8 | else | (M, N ≥ 16) |
| Transform | NSPT8 × 8 | NSPT8 × 16 | NSPT16 × 8 | DCT-II + | DCT-II + |
| | | | | LFNST8 | LFNST16 |

All NSPTs includes 35 sets and 3 candidates (similar to the current LFNST). The kernels of NSPTs have the following shapes:
NSPT4×4: 16×16
NSPT4×8/NSPT8×4: 32×20
NSPT8×8: 64×32
NSPT4×16/NSPT16×4: 64×24
NSPT8×16/NSPT16×8: 128×40

In some embodiments, 12, 32, 40 and 88 coefficients are zeroed-out using NSPT4×8/NSPT8×4, NSPT8×8, NSPT4×16/NSPT16×4 and NSPT8×16/NSPT16×8 respectively.

### IV. Cross Component Prediction

a. Cross Component Linear Model (CCLM)

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β$$

where pred_{C}(i, j) represents the predicted chroma samples in a CU and rec_{L} (i, j) represents the downsampled reconstructed luma samples of the same CU. The CCLM parameters (a and B) are derived with at most four neighbouring chroma samples and their corresponding down-sampled luma samples. Suppose the current chroma block dimensions are WxH, then W′ and H′ are set as
W′=W, H′=H when LM_LA mode is applied
W′=W+H when LM_A mode is applied
H′=W+H when LM_L mode is applied

The terms of {LM_LA, LM_L, LM_A} and {CCLM_LT, CCLM_L, CCLM_T} are used interchangeably in this disclosure.

b. Multi-Model CCLM (MMLM)

Multiple model CCLM mode (MMLM) uses two models for predicting the chroma samples from the luma samples for the whole CU. Similar to CCLM, three multiple model CCLM modes (MMLM_LA, MMLM_A, and MMLM_L) are used to indicate if both above and left neighboring samples, only above neighboring samples, or only left neighboring samples are used in model parameters derivation. The terms of {MMLM_LA, MMLM_A} and {MMLM_LT, MMLM_T} are used interchangeably in this disclosure.

In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold is calculated as the average value of the neighbouring reconstructed luma samples. A neighbouring sample at [x,y] with Rec′_{L}[x,y]<=Threshold is classified into group 1; while a neighbouring sample at [x,y] with Rec′_{L}[x,y]>Threshold is classified into group 2. Thus, the multi-model CCLM prediction for the chroma samples is:

$$P r e {d}_{c} [ x , y ] = {α}_{1} \times {Rec}_{L}^{′} [ x , y ] + {β}_{1} if {Rec}_{L}^{′} [ x , y ] \leq Threshold$$

$$Pre {d}_{c} [ x , y ] = {α}_{2} \times {Rec}_{L}^{′} [ x , y ] + {β}_{2} if {Rec}_{L}^{′} [ x , y ] > Threshold$$

c. Convolutional Cross-Component Model (CCCM)

In some embodiments, a convolutional cross-component model (CCCM) is applied to improve the cross-component prediction performance. For some embodiment, the convolutional model has 7-tap filter having a 5-tap plus sign shape spatial component, a non-linear term and a bias term.

Output of the filter is calculated as a convolution between the filter coefficients ci and the input values and clipped to the range of valid chroma samples. The filter coefficients are calculated by minimising MSE between predicted and reconstructed chroma samples in the reference area. The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

CCCM mode with 3×2 filter for non-downsampled luma samples may be used. The filter has 6-tap spatial terms, four nonlinear terms and a bias term as shown in the following:

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) >> bitDepth ) + {α}_{10} \cdot β + offsetChroma$$

The 6-tap spatial terms correspond to 6 neighboring luma samples (i.e., L0, L1, . . . , L5) around one chroma sample (i.e., C) to be predicted, the four non-linear terms are derived from the samples L0, L1, L2, and L3.

d. Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signaling, when the CCLM mode is enabled for the current CU, two flags are signaled separately for Cb and Cr components to indicate whether GLM is enabled for each component; if the GLM is enabled for one component, one syntax element is further signaled to select one of 16 gradient filters for the gradient calculation. The GLM can be combined with the existing CCLM by signaling one extra flag in bitstream. When such combination is applied, the filter coefficients that are used to derive the input luma samples of the linear model are calculated as the combination of the selected gradient filter of the GLM and the down-sampling filter of the CCLM.

e. Cross-Component Residual Model (CCRM)

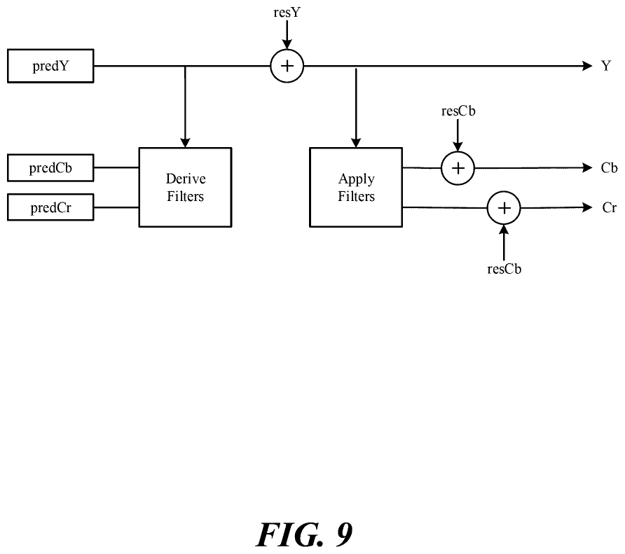

Cross-component residual model (CCRM) may be applied to predict chroma samples from reconstructed luma samples when the block uses inter prediction or intra block copy (IBC). FIG. 9 illustrates reconstruction of component samples using cross-component residual model (CCRM). The figure illustrates the decoder side of the method. The cross-component filters are derived using the prediction signals of luma and chroma. The derived filters are applied to the reconstructed luma signal producing the final chroma predictions.

The term “LM” in this disclosure can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T. The proposed methods (for CCLM) in this disclosure can be used for any other cross-component modes.

### V. Intra Block Copy

Intra block copy (IBC) is implemented as a block level coding mode, block matching (BM) is performed at the encoder to find the optimal block vector (or motion vector) for each CU. Here, a block vector (BV) is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### VI. Deriving and Using Cross-Component Model

a. Cross-Component Prediction for Inter-Coded Block

Some embodiments of the disclosure provide a method that uses cross-component information to improve prediction accuracy of an inter block. To improve the prediction accuracy of the chroma component of the inter block, the luma information from the corresponding luma component of the current chroma block, and/or the chroma information from the current chroma block, and/or the chroma information from a previous coded chroma block may be used.

In some embodiments, for a coding unit (under single tree splitting) including luma (Y) and chroma (Cb and/or Cr) components, the prediction for Cb and/or Cr is improved by applying the cross-component models to information (current reconstructed or predicted) from Y. In some embodiments, for a coding unit (under single tree splitting) including luma (Y) and chroma (Cb and/or Cr) components or for a coding unit (under chroma dual tree splitting) including chroma (Cb and/or Cr) components, the prediction for Cr is improved by applying the cross-component models to information (current reconstructed or predicted) from Cb.

b. CCLM for Inter Block

CCLM for inter block can also be named as inter CCLM and “CCLM” can be extended to any LM mode, or any cross-component mode, or replaced with any LM mode. When convolutional cross-component models derived by a regression-based method is used, CCLM for inter block can also be named as inter CCCM. In some embodiment, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to output the current prediction.

In some embodiments, the current prediction is the weighted sum of inter prediction and CCLM prediction. In some embodiments, the inter prediction can be generated by any inter mode mentioned in the above introduction/documents. For example, the inter mode can be regular merge mode. For another example, the inter mode can be CIIP mode. For another example, the inter mode can be GPM or any GPM variations (e.g., GPM intra referring one prediction unit using intra prediction).

In some embodiments, inter CCLM is supported only when any one (or more than one) of the pre-defined inter mode is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

c. Cross-Type Referencing

In some embodiments, when the current inter block uses any cross-component model (e.g., the inherited cross-component model, the self-derived cross-component model, cross-component model used in chroma fusion which means the chroma prediction is based on adding one or more hypotheses of cross-component prediction to one or more existing hypotheses of prediction of non-cross-component prediction), or any combination of the above, the used model parameters can be saved and/or referenced by the following coding blocks. For an example of the inherited CCCM, all or any subset of the model parameters can be saved. In some embodiments, if the following coding block is intra, it is allowed to use the saved model parameters. If the following coding block is inter or another mode-type (e.g., IBC), it is allowed to use the saved model parameters. In some embodiments, if the following block and the reference block containing the saved model parameters belong to different mode types (one being intra and one being inter), the buffers for storing the model parameters can be different. In some embodiments, if the following coding block has a different mode-type than that of the current block (e.g., not an inter block), it is not allowed to use the saved model parameters.

d. Generate Hypotheses of Prediction for Chroma Component

In some embodiments, prediction or reconstruction-based model is used to generate one hypothesis of prediction for the current chroma component. In some embodiments of a prediction based linear model, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampled with the downsampling filters (which may be fixed at one-predefined filter or selected among some candidate filters). In some embodiments of a reconstruction based linear model, the derived model parameters are applied to the reconstructed samples for the first component (Y) to get the predicted samples for the second or third component.

$$P ( i , j ) = a \cdot {reco}_{L}^{′} ( i , j ) + b$$

The reconstructed samples for the first component may be down-sampled with the downsampling filters (which may be fixed at one-predefined filter or selected among some candidate filters). Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

In some embodiments, multiple-hypotheses (MH) of cross-component predictions are blended or multiple models are used to generate a hypothesis of prediction for the current block. Each CCLM method is suitable for different scenarios. For some complex feature, the combined prediction may bring better performance. Therefore, multiple-hypothesis CCLM is proposed to blend the predictions from multiple CCLM methods. The to-be-blended CCLM methods can be from (but are not limited to) the above mentioned CCLM methods and/or models defined in Section IV, Section VI and Section VII. In some embodiments, a weighting scheme is used for blending.

e. Self-Derived Cross-Component Model

For some embodiments, an example of the self-derived cross-component model is CCRM. When performing the self-derivation, the model (filtering shape/pattern, parameter terms) is unified with the model in regular intra. For example, CCRM model can be unified with any pre-defined existing intra cross-component model (e.g. CCCM using non-downsampled luma samples, GLM, MMLM) and/or the self-derivation only means the input of deriving model parameters is from the current chroma and collocated luma samples (for example, motion compensation results if the current block is inter).

In some embodiments, the self-derived cross-component candidate refers to one or more models and the models are used to generate the cross-component prediction of the current block as follows. The cross-component prediction (used for generating target predicted samples) of the current bock is formed by combining one or more proposed source terms and the models (referring to a proposed weighting setting) according to:

$$pred ( i , j ) = ( sourceTermSet 0 ( i , j ) + sourceTermSet 1 ( i , j ) + … + biasTermSet )$$

With the proposed weighting setting where (i, j) is a sample position in the current block, and pred (i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

SourceTermSet0 (i, j) includes one or more luma source terms denoted as sourceTerm0₀, sourceTerm0₁, . . . , and/or sourceTerm0ₙ₋₁. The value of n means the number of taps for the source term set. In some embodiments, the source terms can be linear terms and/or non-linear terms, only linear terms, and/or only non-linear terms. In another embodiment, n is a pre-defined value such as 1, 2, . . . or any positive integer.

SourceTermSet1 (i, j) includes one or more chroma (Cb or Cr) source terms denoted as sourceTerm0₀, sourceTerm0₁, . . . , and/or sourceTerm0ₘ₋₁. The value of m means the number of taps for the source term set. In one embodiment, the source terms can be linear terms and/or non-linear terms, only linear terms, and/or only non-linear terms. In another embodiment, m is a pre-defined value such as 1, 2, . . . or any positive integer.

biasTermSet includes one or more bias terms. Bias term is a pre-defined value. In one embodiment, the bias term is a midValue according to bitDepth specified in the standard. For example, the bias term is set as (1<< (bitDepth−1)). In another embodiment, the bias term is the same for each sample in the current block. That is, the bias term is regardless of the position (i, j).

In some embodiments, for SourceTermSet0 (i, j) that includes n taps (sourceTerm0₀, sourceTerm0₁, . . . , and/or sourceTerm0ₙ₋₁), the pattern of the n taps refers to a pattern defined as any subset of a window region M×N around/including the position (iL, jL). If the target sample is luma, (iL,jL) is (i, j). If the target sample is chroma (e.g., Cb or Cr), (iL, jL) is the collocated luma position from (i, j).

In some embodiments, for SourceTermSet1(i, j) that includes m taps (sourceTerm0₀, sourceTerm0₁, . . . , and/or sourceTerm0ₘ₋₁), the pattern of the m taps refers to a pattern defined as any subset of a window region M2×N2 around/including the position (i_{C}, j_{C}). If the target sample is chroma (Cb or Cr), (i_{C},j_{C}) is (i, j). If the target sample is luma, (i_{C}, j_{C}) is the collocated chroma position from (i, j).

In some embodiments, a weighting setting is used to estimate the relationship (minimize the distortion) between “the predicted and/or reconstructed samples on the reference region of the current (chroma) block” and “the predicted and/or reconstructed samples on the reference region of the corresponding luma block” by a pre-defined regression method. A weighting (referring to model parameters) is generated according to the regression method, and then the weighting is applied on the source terms to get the target (predicted) samples in the current block. In one embodiment, the pre-defined regression method can be linear minimum mean square error (LMMSE) method as CCLM or can be any unified method with the regression method used for CCLM. In some embodiments, the pre-defined regression method can be the LDL decomposition method as CCCM or can be any unified method with the regression method used for CCCM. In another embodiment, the pre-defined regression method can be Gaussian elimination.

In some embodiment, the spatial neighboring region of the current block may include the above reference region, the left reference region, the above-left reference region, and/or any subset of the above. The reference region of the corresponding luma block is the spatial neighboring region of the corresponding luma block.

The size of the above reference region is A_{w}×A_{H}, the size of the left reference region is L_{w}×L_{H}, and the size of the above-left reference is AL_{W}×AL_{H}. Denote the block width of the current block as W, and denote the block height of the current block as H. A_{w}=block width of the current block (W), k*W (k can be a positive value), W+block height of the current block (i.e., W+H), any pre-defined value, or any adaptive value depending on the block position, block width, block height, and/or block area of the current block.
A_{H} or AL_{H}=H, any pre-defined value (1, 2, 4, . . . ), or any adaptive value depending on the block position, block width, block height, and/or block area of the current block.
L_{W} or AL_{W}=W, any pre-defined value (1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

In some embodiments, the reference region of the current block is the vector-collocated region of the current block and the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results obtained by using the motion information (block vectors and current picture) of the current block, and the vector-collocated region of the corresponding luma block refers to the motion compensated results obtained by using the motion information (block vectors and current picture) of the corresponding luma block.

In some embodiment, the above-proposed two kinds of the reference region of the current block can be used together. For example, generally, samples in the vector-collocated region of the current block are used as input samples when deriving model parameters; however, for a smaller block, samples in the spatial neighboring reference region are used as additional input samples when deriving model parameters.

f. Representative Prediction Mode for Transform Selection

In some embodiments, operations of encoding or decoding stages are determined based on the prediction mode used for the current block. For example, in some embodiments, the type of transform that is to be performed on the prediction residual of the current block may be selected based on an intra-prediction mode (e.g., DC, planar, directional modes) that is associated with the current block. In some embodiments, for a block that is not coded by conventional same-component intra-prediction but rather by cross-component prediction, a representative intra-prediction mode may be identified or derived for the purpose of determining the operations of the encoding or decoding stages, such as selecting the primary and/or secondary transform type.

In another embodiment, a representative prediction mode is derived when the cross-component prediction is used for the current chroma block. The motivation of deriving a representative prediction mode is that on the following encoding/decoding stages after/before/parallel to prediction process, it will use the intra prediction mode (e.g., DC, planar, directional modes) for the current block. However, cross-component model is not one of the mentioned intra prediction mode. So, a representative prediction mode is needed.

In some embodiments, on the transform/inverse transform stage, the representative prediction mode is used by primary transform (e.g., separable primary transform like MTS, non-separable primary transform like NSPT) and/or secondary transform (e.g., LFNST) to select the transform set and/or the transpose flag. The secondary transform is not limited to LFNST and can be any pre-defined separable/non-separable and/or low-frequency/non-low-frequency transform which is performed after (or before) primary transform at encoder (or decoder) and is applied to the primary-transformed (or received-dequantized) coefficients at encoder (or decoder).

In some embodiments, for a subsequent coding block, it may reference the intra prediction mode information of its neighboring blocks to derive its MPM list. The neighboring blocks that the subsequent block references may be coded in cross-component mode (hence do not have non-cross-component intra prediction mode information, particularly, no directional intra prediction mode information). For this subsequent block, the intra prediction mode information from one or more neighboring coded blocks of this subsequent block is used to derive the MPM list for chroma component of the subsequent coding block. If the neighboring coded block uses cross-component mode, the representative prediction mode (of the neighboring coded block) is used for deriving the MPM list instead.

In some embodiments, DIMD process (described above in Section I.b) is used to derive the representative prediction mode as the intra prediction mode of the current block. For example, DIMD is performed on the predicted samples or subsampling of the predicted samples within the current chroma block (e.g., cross-component predicted from Y to Cr/Cb or Cr to Cb, etc.). For another example, the DIMD is performed on the reconstructed samples or subsampling of the reconstructed samples on the neighboring template of the current chroma block. When using DIMD, a horizontal gradient and a vertical gradient are calculated for each sample to build a HoG, and then the intra prediction mode with the largest histogram amplitude values is used to determine the representative prediction mode for choosing the transform set and transpose flag.

### VII. Inheriting Cross-Component Models

In some embodiments, previously derived cross-component model and/or corresponding information can be inherited and used for the current chroma block by (1) building a candidate list (modelList) for the current block where the candidate list includes cross-component models, (2) selecting one or more model information in the list, and (3) using the selected model information (similar to intra chroma cross-component mode) to generate one or more hypotheses of predictions for the current chroma component (Cb or Cr) by applying and/or modifying the selected model information to the reconstructed or predicted samples for the corresponding luma component.

When the selected model information refers to traditional cross-component linear model(s), the method is called as inter cross-component linear model (inter CCLM) mode. When the selected model information refers to convolutional cross-component model(s) derived by a regression-based method (as CCCM for example), the method is called inter cross-component convolution model (inter CCCM) mode. Moreover, in some embodiments, a self-derived (or “re-derived”) cross-component mode is added into the candidate list. In some embodiment, the self-derived cross-component mode is not added into the list and a selection of using the proposed inherited mode and/or using the proposed self-derived mode is designed. In some embodiments, the selection of using the proposed inherited mode and/or using the proposed self-derived mode is determined following an explicit rule, an implicit rule, or both. This candidate list selection method will be described in more detail in Section VIII below.

a. Selection of Inherited Mode and/or Re-Derived Mode

In some embodiments, a flag can be signaled to indicate/select if the re-derived model (or “self-derived model” as described in Section VI.e) is used. If the flag is 0, the cross-component model used to encode the neighbor merge candidate is inherited. If the flag is 1, the re-derived method is used. In some embodiments, an implicit rule (not using the additional flag) is used to determine whether to use the re-derived model. In some embodiments, if no model can be inherited during building the modelList or the spatial adjacent and/or non-adjacent candidates and/or history candidates and/or temporal candidates and/or all or any subset (e.g., before default candidates) of mentioned candidates in this document are not available, the re-derived model can be used.

In some embodiments, when the inherited method is used, a candidate with the smallest cost (e.g., the first candidate in the modelList) is implicitly selected to generate the cross-component prediction. In some embodiments, an index is signaled to select one or more candidates from the modelList. More details on selection of candidate from the modelList can be found in Section VIII.

b. Storing Model Parameters for Inheritance

In some embodiments, when the current inter block uses the model parameters from the self-derived cross-component mode, the used model parameters can be saved and/or be referenced by the following or subsequent coding blocks. For an example of the self-derived cross-component being CCRM, all or any subset of the model parameters can be saved. In some embodiments, if the following coding block is intra coded, it is allowed to use the saved model parameters. If the following coding block is inter coded or another mode-type (e.g., IBC), it is allowed to use the saved model parameters. In some embodiments, if the following block and the reference block containing the saved model parameters belong to different mode types (one being intra and one being inter), the buffers for storing the model parameters can be different. In some embodiments, if the following coding block has a different mode-type than that of the reference block (e.g., not an inter block), it is not allowed to use the saved model parameters.

In some embodiments, when the current inter block uses the inherited cross-component mode, the used model parameters can be saved and/or be referenced by the following or subsequent coding blocks. For an example of the inherited CCCM, all or any subset of the model parameters can be saved. In some embodiments, if the following coding block is intra coded, it is allowed to use the saved model parameters. If the following coding block is inter coded or any mode-type (e.g., IBC), it is allowed to use the saved model parameters. In some embodiments, if the following block and the reference block containing the saved model parameters belong to different mode types (e.g., one being intra and one being inter), the buffers for storing the model parameters can be different. In some embodiments, if the following coding block has a different mode-type than that of the reference block (e.g., not an inter block), it is not allowed to use the saved model parameters.

c. Inheriting CCM Information

In some embodiments, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM (GLM model with luma term), model index for indicating which model shape is used in convolutional model, classification threshold for multi-model, information to indicate non-downsampled samples are used in convolutional model, down-sampling filter flag (whether to do down-sampling), down-sampling filtering index when multiple down-sampling filters are used, number of neighboring lines used to derive model, types of templates used to derive model, post-filtering flag and model parameters.

In some embodiments, a mixed CCCM model having various terms (e.g., spatial term, gradient term, location term, non-linear term and bias term) can be inherited. In addition to storing model parameters, a prediction mode can be stored in the CCM information to indicate that the inherited model is a mixed CCCM model consists of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 is a mixed CCCM model which includes one spatial term in center position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model. In some embodiments, the inherited model parameters can be refined and then used for the current block and/or saved for/referenced by the following coding blocks.

d. Inheriting Spatial Neighboring Model Parameters

In some embodiments, the inherited model parameters can be from a block that is an immediate neighboring block. The models from blocks at pre-defined positions are added into the candidate list in a pre-defined order. The pre-defined order could be any possible order of the spatial neighbor block. In some embodiments, the pre-defined positions and the pre-defined order can be the same as those of spatial candidates for inter merge mode. In some embodiments, the pre-defined positions can be the positions depicted in FIG. 2, which illustrates pre-defined positions of spatial neighboring blocks. The pre-defined order can be B0, A0, B1, A1 and B2.

In some embodiments, assume the position, width and height of the current block are (x, y), W and H respectively, the pre-defined positions can include positions immediate above the current block, such as (x+W>>1, y−1) or (x+ (W+1)>>1, y−1), if W is greater than or equal to a threshold TH. The pre-defined positions can also include positions immediate left to the current blocks, such as (x−1, y+H>>1) or (x−1, y+(H+1)>>1), if H is greater than or equal to a threshold TH. TH can be 2, 4, 8, 16, 32, or 64. The pre-defined positions include the positions at the immediate above (W>>1) or ((W>>1)−1) position if W is greater than or equal to TH, and the positions at the immediate left (H>>1) or ((H>>1)−1) position if H is greater than or equal to TH.

In some embodiments, there is a maximum number of inherited models from spatial neighbors that can be added into the candidate list, and the maximum number is smaller than the number of pre-defined positions.

e. Inheriting Temporal Neighbor Model Parameters

In some embodiments, if the current slice/picture is a non-intra slice/picture, the inherited model parameters can be from the block in the previous coded slices/pictures (i.e., model parameters from temporal neighbors.)

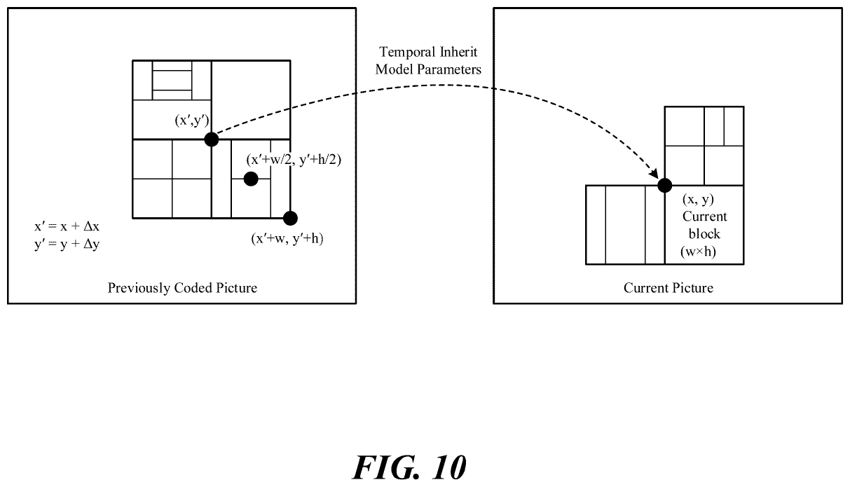

FIG. 10 conceptually illustrates inheriting temporal neighboring model parameters. As illustrated, the current position is at (x, y) and the block size is w×h. The inherited model parameters could from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In some embodiments, Δx and Δy are set to 0. In some embodiments, if the prediction mode of the current block is inter, Δx and Δy are set to the horizontal and vertical motion vector of the current block as the first case in “Temporal model information from collocated blocks” in Section VIII.b. In some embodiments, if the current block is inter uni-prediction, Δx and Δy are set to the horizontal and vertical motion vector in either reference picture list 0 or 1 depending on which list used for the current block. In some embodiments, if the current block is inter bi-prediction, Δx and Δy are set to the horizontal and vertical motion vectors in reference picture list 0. In some embodiments, if the current block is inter bi-prediction, Δx and Δy are set to the horizontal and vertical motion vector in reference picture list 1.

In some embodiments, if the current slice/picture is a non-intra slice/picture, the inherited model parameters can be from the block in the previous coded slices/pictures. In some embodiments, the current block position is at (x, y) and the block size is w×h. The inherited model parameters can be from the block at some pre-defined positions of the previous coded slices/picture.

In some embodiments, the pre-defined positions can be (x+Δx, y+Δy) or (x_{mid}+Δx, y_{mid}+Δy), where

$$( {x}_{mid} , {y}_{mid} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. For example, (Δx, Δy) can be (±αₓᵢ×w, ±α_{yi}×h), (±αₓᵢ×w, 0), (0, ±α_{yi}×h). For example, (Δx, Δy) can be (±αₓᵢ×δx, ±α_{yi}×δy), (±αₓᵢ×δx, 0), (0, ±α_{yi}×δy), where δx and δy are two fixed positive numbers. For example, αₓ=α_{y}. For example, αₓ=α_{y}={1, 2, 3, 4, 5}. For example, αₓ≠α_{y}. For example,

$${α}_{x} = \{ \frac{w}{2} , 1 , \frac{3}{2} , 2 , \frac{5}{2} \}$$

and α_{y}={1, 2, 3, 4, 5}.

In some embodiments, the pre-defined positions (x′, y′) are inside the corresponding area of the current encoding block, i.e., x≤x′<x+w and y≤y′<y+h. The pre-defined positions can be (x, y), (x+w−1, y), (x, y+h−1), (x+w−1, y+h−1),

$$( x + \frac{w}{2} , y + \frac{h}{2} ) , ( x , y + \frac{h}{2} ) , ( x + \frac{w}{2} , y ) .$$

In some embodiments, the pre-defined positions (x′, y′) are outside of the corresponding area of the current encoding block, i.e., x′<x+ or x′≥x+w, and y′<y or y′≥y+h. The pre-defined positions can be (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In some embodiments, the models from the positions closer to (x, y) are added into the final merge candidate list first. The previous coded picture, from which the inherited parameter model is obtained, is referred to as the collocated picture hereafter. In some embodiments, the previous coded picture the inherited parameter model is from, i.e., the collocated picture, is one of the pictures in the reference lists. In some embodiments, the collocated picture is signaled in the picture/slice header. The reference list and the reference index are signaled in the picture/slice header. For example, the collocated picture is selected as L0[0]. For another example, the collocated picture is selected as L1[0].

f. Inheriting Non-Adjacent Spatial Neighboring Models

In some embodiments, the inherited model parameters can be from blocks that are non-adjacent spatial neighboring blocks. The models from blocks at pre-defined positions are added into the candidate list in a pre-defined order. In some embodiments, the pre-defined positions and the pre-defined order are the same as those of non-adjacent spatial neighboring candidates for inter merge mode.

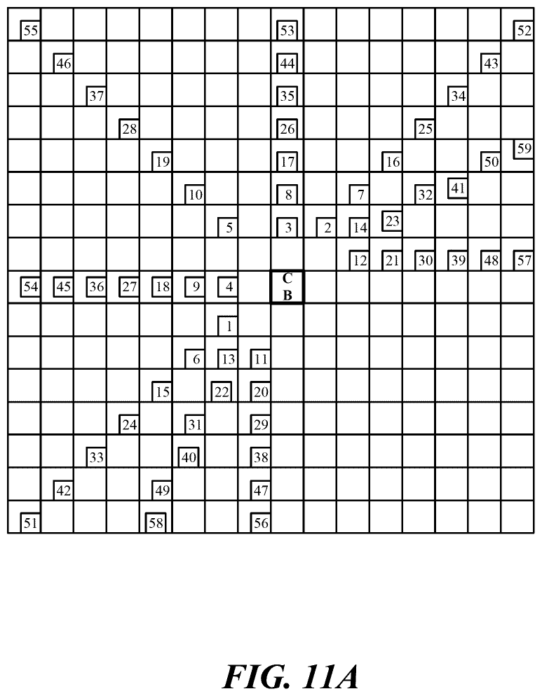

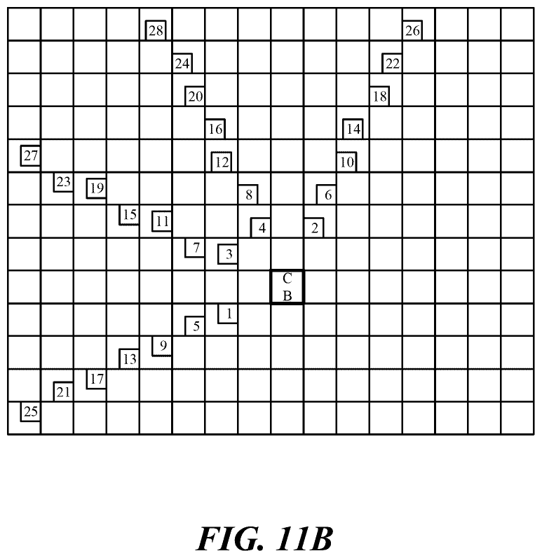

FIGS. 11A-B illustrate a current block 1100 and its non-adjacent spatial neighboring blocks, from which model parameters may be inherited. The figure also illustrates the pre-defined positions and their pre-defined order. FIG. 11A shows non-adjacent spatial positions in their pre-defined order according to a first pattern (Pattern 1). FIG. 11B shows non-adjacent spatial positions in their pre-defined order according to a second pattern (Pattern 2). The positions of the numbered squares are the pre-defined positions. The number inside each square indicates the pre-defined order. Positions in Pattern 1 is added into the list before positions in Pattern 2. The distance between each pre-defined positions are proportional to the width and height of the current block.

In some embodiments, there is a maximum number of inherited models from non-adjacent spatial neighbors that can be added into the candidate list, and the maximum number is smaller than the number of pre-defined positions.

g. Inheriting Model Parameters from History Table

In some embodiments, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In some embodiments, the adding order of historical candidate can be from the beginning of the table to the end of the table. In some embodiments, the adding order of historical candidate can be from the end of the table to the beginning of the table.

In some embodiments, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In another embodiment, the cross-component model history table can be reset at the end of the current picture, current slice, current tile, current CTU row or current CTU.

In some embodiments, multiple history table are used for storing different types of cross-component model. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In some embodiments, when adding historical candidates from multiple history tables to the candidate list, the adding order can be from the beginning of to the end of a certain table, and then the next history table is added in the same order or in a reversed order.

VIII. Candidate Lists with Cross-Component Models
a. Cross-Component Model Estimation Region (CCMER)

In some embodiments, the blocks in a same pre-defined region (e.g., CCMER) can share the same candidate list (i.e., modelList) or partially the same modelList (for example, adjacent/non-adjacent and/or history candidates are the same). In some embodiments, cross-component model estimation region (CCMER) allows independent derivation of modelList for the blocks (e.g., CUs, TUs, and/or any pre-defined regions) in the same cross-component model estimation region (CCMER). Independent derivation of modelList (i.e., a merge candidate list) for different blocks (e.g., CUs, TUs, and/or any pre-defined regions) are allowed in a same cross-component model estimation region (CCMER). That is, the model of a certain block will not be inserted into the merge list for another block if the two blocks are in the same CCMER. A candidate block that is within the same CCMER as the current block (e.g., CUs, TUs, and/or any pre-defined regions) is not included for the generation of modelList of the current block.

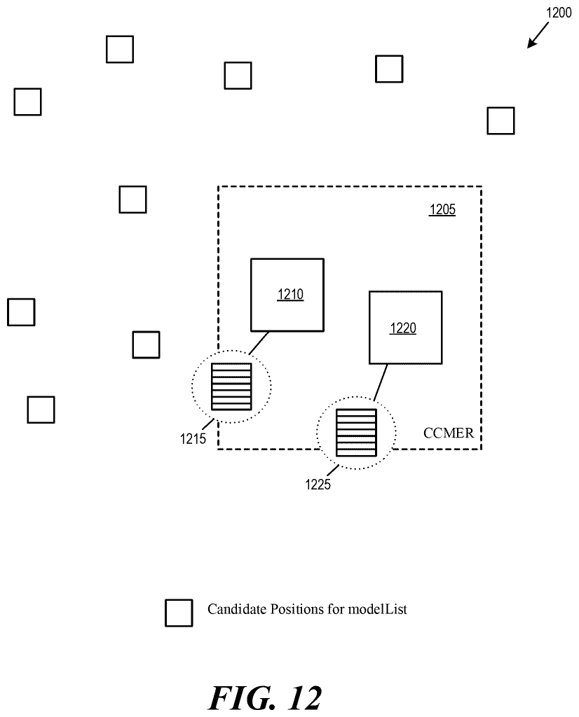

FIG. 12 conceptually illustrates candidate lists for blocks in a same cross-component merge estimation region (CCMER). The figure illustrates a CCMER 1205 in a picture 1200. Block 1210 is in the CCMER 1205 and uses a modelList 1215. Block 1220 is also in the CCMER 1205 and uses a modelList 1225. Candidate models or information of both modelList 1215 and modelList 1225 are from candidate positions outside of CCMER 1205. Information from blocks 1210 and 1220 are not included as candidates in modelList 1215 and modelList 1225 since the blocks are in CCMER 1205.

In some embodiments, the updating process for a history-based model candidate list (the FIFO table for history-based model information) is updated only if the block size (block width and/or block height) is larger than a threshold, and such a threshold may be determined based on the size of the CCMER. For example, the threshold (i.e., CCMER size) is fixed at a positive integer such as 4, 8, 16, 32, 64, 128, 256, or any positive integer value, the threshold is specified at the standard, and/or the threshold depends on the signalling at on block, slice, picture, SPS, or PPS level. The following shows an implementation for some embodiments:

The updating process for the history-based model candidate list (the FIFO table for history-based model information) is updated only if (blockPostitionX+blockWidth)>>Log2ParCCMrgLevel is greater than blockPostitionX>>Log2ParCCMrgLevel and (blockPostitionY+blockHeight)>>Log2ParCCMrgLevel is great than (blockPostitionY>>Log2ParCCMrgLevel). If the block refers to a CU, (blockPostitionX, blockPostitionY) is the top-left luma sample position of the current CU in the picture and (blockWidth, blockHeight) is the CU size. The CCMER size is selected at encoder side and signalled as log2_parallel_ccmerge_level_minus2 in the sequence parameter set and Log2ParCCMrgLevel=sps_log2_parallel_ccmerge_level_minus2+2. For another example, CCMER size is unified with and/or derived using the size of Merge estimation region (MER) for regular merge.

b. Candidate List Including Cross-Component Models

In some embodiments, for each candidate in the list, it refers to a candidate model information. The definition of the model information can be found in the Section VII.c “Inheriting CCM information” above. when building the merge-like candidate model list (modelList), one or more of the following candidate model information are included:
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In some embodiments, when the candidate type is “Spatial model information from spatial neighbour blocks”, a valid spatial neighboring block(s) can be from one of spatial adjacent and non-adjacent neighbors (or any subset of the blocks in a neighboring search region for the current block) which satisfies a pre-defined condition. For an example of non-adjacent neighbors, the pre-defined condition (e.g., valid/available checking) refers to that the non-adjacent neighbor is in the available region of non-adjacent spatial candidates. For example, the pre-defined condition is that the neighbor is coded by a cross-component mode (such as CCLM, MMLM, CCCM, GLM, the mode with mode information inherited from a merge-like candidate list, MH CCLM, and/or any cross-component mode with syntax belonging cross-component branch (containing many cross-component modes) and not belonging to tradition intra prediction modes) or by a mode combining with cross-component modes (such as chroma fusion (or named LM assisted Angular/Planar Mode), inter CCLM, inter CCCM and/or any traditional mode with syntax not belonging to cross-component branch but using the cross-component information to generate the prediction).

In some embodiments, when checking the validation of a neighboring coding block, a second-round valid checking is further used when the mentioned valid checking (e.g., neighboring block not being cross-component mode or neighboring block not using/combining cross-component mode), the motion vectors and/or block vectors of the neighboring block can be used to find the cross-component models. Variations of how to use motion vector and/or block vectors to find the model can reference in the description of “temporal model information from collocated blocks”. If found, a second-round valid checking for the neighboring block is satisfied and the found models can be inserted in the list; otherwise, the neighboring block is not valid for inserting. When scanning the spatial neighboring blocks, a candidate is added into the list if the candidate is valid. The following show some scanning orders when adding the Spatial model information from spatial neighbour blocks into the list. More details can be found in Section VII.d “Inheriting spatial neighboring model parameters” and Section VII.f “Inheriting non-adjacent spatial neighboring models”.

In some embodiments, for temporal model information from collocated blocks, in a first case, the collocated block is from the block, located by using the current block position and/or the current block motion, in the reference picture or the pre-defined collocated picture as inter mode; and/or in a second case, the collocated block is from the block, located by using the current block position and/or the neighboring block motion, in the reference picture or the pre-defined collocated picture as inter mode. In the first case (current block motion), for example, when the current block is coded by inter prediction mode, the collocated block is referred by the motion information (including the motion vectors and the reference picture indicated by the reference index) of the current block.

If the current block is a subblock motion mode (e.g., affine mode), each subblock in the current block has its own collocated temporal model information and/or all or any subset of collocated temporal model information referred by the different subblock motions are added into the list. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the temporal information from the reference picture is forbidden to be used. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the motion vector is scaled to refer the pre-defined collocated picture and the scaled motion vector is used to find the collocated block in the collocated picture to get the cross-component model in the collocated block. The scaling process is shown in Section VII.e “Inheriting temporal neighboring model parameters”.

For the above mentioned second case (neighboring block motion), for one example, the temporal model information can be from the collocated block referred by the motion information of the neighboring blocks of the current block. Similar to the first case (current block motion) mentioned above, the forbidden method or the scaling method can be used in the second case (neighboring block motion) mentioned above. If the proposed methods are applied to an IBC block or any mode using block vectors (in the first case, the current block being IBC; in the second case, the neighboring block being IBC), block vector information is used as motion vector where the block vector information is determined by signalling and/or template matching in a pre-defined searching range like intraTMP and/or any implicit or explicit pre-defined rules. In some embodiments, forbidden method is applied when the temporal information is not from the available region of temporal candidates. More details can be found in Section VII.e “Inheriting temporal neighboring model parameters”.

In some embodiments, for history-based model information, a history-based table (the FIFO table) is built and stores the model information from the previous coded blocks. The table can be reset at the beginning and/or end of a CTU, slice, picture, tile, and/or sequence. One or more history-based candidates can be added into the candidate list by the order from the head to tail of the table or from the tail to head of the table. More variations can be found in Section VII.g “Inheriting model parameters from history table”.

In some embodiments, for pairwise average model information, the model information of this candidate is derived based on the model information from more than one of the previous candidates in the list. For example, the video coder may average and/or modify the model parameters of more than one candidate as the to-be-applied model parameters. For another example, the video coder may combine more than one predictions as the final prediction, where each of the more than one predictions is generated by applying one of models in the candidate list.

In some embodiments, the default model information is added if the list is not full after inserting all pre-defined candidates. Some examples of the default CCLM model information are shown below.

For example, the default alpha (or named as α, a, or scaling parameters) are {0, 1/8, −1/8, 2/8, −2/8, 3/8, −3/8, . . . }, and the beta (or named as β, b, or offset parameter) is based on the selected default alpha, average neighboring reconstructed luma sample value, and average neighboring reconstructed chroma (Cb/Cr) sample value.

In some embodiments, when selecting one candidate from the list and using the model information from the candidate for the current block, or when inheriting the model information from a previous coded block (when putting one candidate into the list), only a subset of the model information is inherited. For example, only the alpha is inherited. The beta is obtained for the current block through the inherited alpha, average neighboring reconstructed luma sample value, and/or average neighboring reconstructed chroma (Cb/Cr) sample value. For example, when inheriting MMLM model information, the scaling parameters and/or the classification threshold are inherited. The offset parameter in each class is derived according to the inherited classification threshold and the average neighboring reconstructed luma sample value, and/or average neighboring reconstructed chroma (Cb/Cr) sample value in each class. If no neighboring reconstructed samples are available in a class, the offset parameter is directly inherited from the candidate. For example, when inheriting CCCM model information, all convolution parameters, offsets, and/or the classification threshold are inherited. For example, when inheriting GLM model information, if the GLM candidate is 3-parameter GLM mode, all the gradient pattern indices and model parameters are inherited; otherwise, if the GLM candidate is the 2-parameter GLM mode, the offset parameter is derived by using the inherited scaling parameter, average neighboring reconstructed luma sample value, and/or average neighboring reconstructed chroma (Cb/Cr) sample value. For example, when inheriting chroma fusion model information, the derived MMLM parameters are inherited and used as when inheriting a MMLM candidate for the current block.

In some embodiments, when building the modelList, one or more self-derived cross-component candidates (described in Section VI.e) are included. In some embodiments, the self-derived cross-component candidates are added only when the list contains not enough inherited candidates. For example, the self-derived candidates are before the default candidates or treated as the default candidates. In some embodiments, the self-derived cross-component candidates are added in any pre-defined position in the modelList. For example, the position is after the spatial adjacent candidates. For another example, the position is after the spatial non-adjacent candidates.

For another example, the position is after all or any subset of temporal candidates. More details/variations of construction of the modelList can be found in Sections VII and VIII.

c. Order of Inserting a Candidate to the List

In some embodiments, the candidate list is constructed by adding candidates in a pre-defined order until the maximum candidate number is reached. The candidates added can include all or some of the forementioned candidates, but not limited to the forementioned candidates. For example, the pre-defined order can be spatial adjacent candidates, temporal candidates, spatial non-adjacent candidates, historical candidates, and then default candidates.

In some embodiments, if all the pre-defined neighboring and historical candidates are added but the maximum candidate number is not reached, some default candidates are added into the candidate list until the maximum candidate number is reached.

In some embodiments, the default candidates can be CCLM models. The scaling parameter α is from the set

$$0 , 1 / 8 , - 1 / 8 , + 2 / 8 , - 2 / 8 , + 3 / 8 , - 3 / 8 , + 4 / 8 , - 4 / 8 , … , + N / 8 , - N / 8 \} ,$$

where N is a positive integer. The offset parameter β can be

$$\frac{1}{1 << bit\_depth}$$

or can be derived based on neighboring luma and chroma samples. For example, if the average value of neighboring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order:

$$α = 0 , 1 / 8 , - 1 / 8 , + 2 / 8 , - 2 / 8 , + 3 / 8 , - 3 / 8 , + 4 / 8 , - 4 / 8 , … , + N / 8 , - N / 8$$

In some embodiments, a default candidate can be an earlier candidate with a delta scaling parameter refinement. The earlier candidate is a CCLM model. If the scaling parameter of an earlier candidate is α, the scaling parameter of a default candidate is (α+Δα). For example, Δα can be

$$1 / 8 , - 1 / 8 , + 2 / 8 , - 2 / 8 , + 3 / 8 , - 3 / 8 , + 4 / 8 , - 4 / 8 , … , + N / 8 , - N / 8 ,$$

where N is a positive integer. The offset parameter β can be derived based on (α+Δα) and the average values of neighboring luma and chroma samples of the current block. In some embodiments, the earlier candidate is the first CCLM candidate added into the list. In one sub-embodiment, the inclusion order of the default candidates can depend on the absolute value and the sign of the refinement Aa. For example, the default candidates are added into the list in the following order:

$$Δα = 0 , 1 / 8 , - 1 / 8 , + 2 / 8 , - 2 / 8 , + 3 / 8 , - 3 / 8 , + 4 / 8 , - 4 / 8 , … , + N / 8 , - N / 8.$$

d. Enable/Disable/Selecting Model Information in Candidate List

In some embodiments, when not applying the proposed inter CCLM (or inter CCCM), the prediction of current block is from original inter prediction. In some embodiments, the choice between applying inter CCLM (or inter CCCM) or not applying inter CCLM (or inter CCCM) depends on signaling. In some embodiments, when the signaling indicates to apply inter CCLM (or inter CCCM), additional signaling is used to select one or more than one models from total candidates (e.g., CCLM_LT, CCLM_L, CCLM_T, MMLM_LT, MMLM_T, MMLM_L, or any subset/extension from the above-mentioned modes).

For example, if one LM mode is selected, the LM prediction is generated by the selected one LM. For another example, if more than one LM modes are selected the LM prediction is generated by blending hypotheses of predictions from multiple LM modes. For another example, the additional signaling refers to an index in the bitstream which can be truncated unary coding with and/or without contexts. In another sub-embodiment, the additional signalled is not required and the one or more models are selected according to an implicit rule.

In some embodiments, the one or more selected models are implicitly determined or the one or more models used for the current block are determined without signalling modeldx. For example, the first candidate in the list is used. If the list is reordered by the template cost. Then, the first candidate is the candidate with the smallest template cost. In some embodiments, the sorting in reordering may not be necessary since each candidate in the list can be checked one by one and the candidate with the smallest cost so far is kept. For another example, the used candidate/model are implicitly selected from the list by using a pre-defined rule depending on the coding information of the block for the to-be-used candidate.

In some embodiments, when the signaling indicates to apply inter CCLM (or inter CCCM), one or more models from total candidates (e.g., modelList may comprise candidates as described in Section VIII.b, CCLM_LT, CCLM_L, CCLM_T, MMLM_L, MMLM_T, MMLM_L, or any subset/extension from the above-mentioned modes) is (are) implicitly selected (or predefined) to be used in inter CCLM (or inter CCCM). For example, CCLM_LT is used to generate LM prediction for inter CCLM. For example, MMLM_LT is used to generate LM prediction for inter CCLM. Similar rules can be applied to inter CCCM with using convolutional models instead. For another example of inter CCLM, the predefined rule depends on block width, block height, or block area. Similar rules can be applied to inter CCCM with using convolutional models instead. Rules such as:
Boundary matching setting (used as the predefined rule) can be applied only when the block width, block height, or block area is larger than a threshold.
Boundary matching setting (used as the predefined rule) can be applied only when the block width, block height, or block area is smaller than a threshold.
When the block width, block height, or block area is smaller than a threshold, the selected LM mode(s) is (are) inferred as any one (more than one) LM mode(s) from total candidate LM modes. For example, the selected LM mode is fixed as CCLM_LT, or the selected LM mode is fixed as MMLM_LT.

For another example, the predefined rule depends on boundary matching setting. (The candidate mode used in the boundary matching setting refers to each candidate LM mode for inter CCLM. The prediction from a candidate mode used in the boundary matching setting refers to the prediction generated by each candidate LM mode or refers to the blended prediction of each candidate LM mode and original inter prediction.) Similar rules can be applied to inter CCCM with using convolutional models instead.

In some embodiments, inter CCLM (or inter CCCM) can be supported only when the size conditions of the current block are satisfied. In some embodiment, the size condition is that the block width, block height, or block area is larger than a pre-defined threshold. The predefine threshold can a positive integer like 8, 16, 32, 64, 128, 256, . . . . In some embodiments, the size condition is that the block width, block height, or block area is smaller than a pre-defined threshold. The predefine threshold can a positive integer like 8, 16, 32, 64, 128, 256, 512, 1024, 2048, 4096 . . . .

In some embodiments, original inter prediction (generated by motion compensation) is used for luma and the predictions of chroma components are generated by CCLM and/or any other LM modes. In some embodiments, the current CU is viewed as an inter CU, intra CU, or a new type of prediction mode (neither intra nor inter). In some embodiments, the one or more LM mode(s) (or cross-component mode(s)) which will be used to generate the one or more hypotheses of predictions for LM assisted Angular/Planar Mode/inter CCLM/inter CCCM/MH CCLM are selected from a pre-defined merging candidate list (called modelList). In some embodiments, one modelIdx (model index) is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled and/or can be inferred as 0 or a default value. In one embodiment, the modelIdx is implicitly determined or the one or more models used for the current block are determined without signalling modelIdx. For example, the first candidate in the list is used (i.e., modelIdx=0).

In some embodiments, the candidates in the list can be reordered to reduce the syntax overhead when signaling the selected candidate index or to bypass the syntax for signaling the selected candidate index by using implicit rule to select the one or more candidates. Thus, if the modelList containing total candidates or any subset of candidates are reordered, the additional signalling specifies the candidate index in the reordered list. For example, if the list is reordered by the template cost, then the first candidate is the candidate with the smallest template cost. For another example, the used candidate/model are implicitly selected from the list by using a pre-defined rule depending on the coding information of the block for the to-be-used candidate.

In some embodiments, when building modelList, one or more predefined candidates are added. The pre-defined candidates may include any subset/extension of the following candidates and/or more candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g., IBC merge or IBC AMVP or any IBC mode under IBC syntax). (“Inter coded” in this document can be changed to “IBC coded”.) That is, for chroma components, the block vector prediction can be combined or replaced with cross-component prediction.

Any combination of the proposed methods in this invention can be applied. Any of the foregoing proposed methods can be implemented in encoders and/or decoders. For example, any of the proposed methods can be implemented in an inter/intra/prediction/IBC module of an encoder, and/or an inter/intra/prediction/IBC module of a decoder. Alternatively, any of the proposed methods can be implemented as a circuit coupled to the inter/intra/prediction module of the encoder and/or the inter/intra/prediction/IBC module of the decoder, so as to provide the information needed by the inter/intra/prediction/IBC/quantization module.

### IX. Example Video Encoder

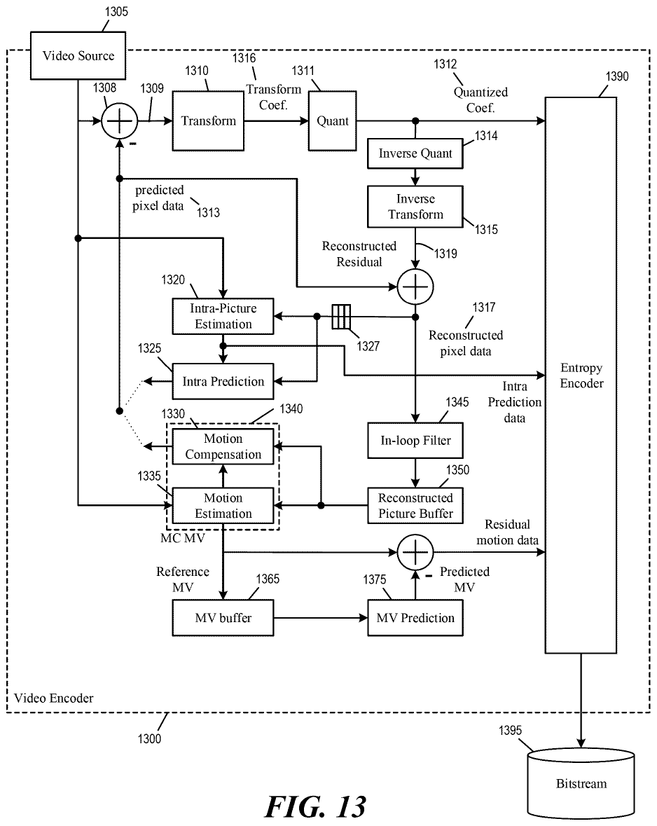

FIG. 13 illustrates an example video encoder 1300 that may implement cross component prediction. As illustrated, the video encoder 1300 receives input video signal from a video source 1305 and encodes the signal into bitstream 1395. The video encoder 1300 has several components or modules for encoding the signal from the video source 1305, at least including some components selected from a transform module 1310, a quantization module 1311, an inverse quantization module 1314, an inverse transform module 1315, an intra-picture estimation module 1320, an intra-prediction module 1325, a motion compensation module 1330, a motion estimation module 1335, an in-loop filter 1345, a reconstructed picture buffer 1350, a MV buffer 1365, and a MV prediction module 1375, and an entropy encoder 1390. The motion compensation module 1330 and the motion estimation module 1335 are part of an inter-prediction module 1340.

In some embodiments, the modules 1310-1390 are modules of software instructions being executed by one or more processing units (e.g., a processor) of a computing device or electronic apparatus. In some embodiments, the modules 1310-1390 are modules of hardware circuits implemented by one or more integrated circuits (ICs) of an electronic apparatus. Though the modules 1310-1390 are illustrated as being separate modules, some of the modules can be combined into a single module.

The video source 1305 provides a raw video signal that presents pixel data of each video frame without compression. A subtractor 1308 computes the difference between the raw video pixel data of the video source 1305 and the predicted pixel data 1313 from the motion compensation module 1330 or intra-prediction module 1325 as prediction residual 1309. The transform module 1310 converts the difference (or the residual pixel data or residual signal 1308) into transform coefficients (e.g., by performing Discrete Cosine Transform, or DCT). The quantization module 1311 quantizes the transform coefficients into quantized data (or quantized coefficients) 1312, which is encoded into the bitstream 1395 by the entropy encoder 1390.

The inverse quantization module 1314 de-quantizes the quantized data (or quantized coefficients) 1312 to obtain transform coefficients, and the inverse transform module 1315 performs inverse transform on the transform coefficients to produce reconstructed residual 1319. The reconstructed residual 1319 is added with the predicted pixel data 1313 to produce reconstructed pixel data 1317. In some embodiments, the reconstructed pixel data 1317 is temporarily stored in a line buffer 1327 (or intra prediction buffer) for intra-picture prediction and spatial MV prediction. The reconstructed pixels are filtered by the in-loop filter 1345 and stored in the reconstructed picture buffer 1350. In some embodiments, the reconstructed picture buffer 1350 is a storage external to the video encoder 1300. In some embodiments, the reconstructed picture buffer 1350 is a storage internal to the video encoder 1300.

The intra-picture estimation module 1320 performs intra-prediction based on the reconstructed pixel data 1317 to produce intra prediction data. The intra-prediction data is provided to the entropy encoder 1390 to be encoded into bitstream 1395. The intra-prediction data is also used by the intra-prediction module 1325 to produce the predicted pixel data 1313.

The motion estimation module 1335 performs inter-prediction by producing MVs to reference pixel data of previously decoded frames stored in the reconstructed picture buffer 1350. These MVs are provided to the motion compensation module 1330 to produce predicted pixel data.

Instead of encoding the complete actual MVs in the bitstream, the video encoder 1300 uses MV prediction to generate predicted MVs, and the difference between the MVs used for motion compensation and the predicted MVs is encoded as residual motion data and stored in the bitstream 1395.

The MV prediction module 1375 generates the predicted MVs based on reference MVs that were generated for encoding previously video frames, i.e., the motion compensation MVs that were used to perform motion compensation. The MV prediction module 1375 retrieves reference MVs from previous video frames from the MV buffer 1365. The video encoder 1300 stores the MVs generated for the current video frame in the MV buffer 1365 as reference MVs for generating predicted MVs.

The MV prediction module 1375 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1395 by the entropy encoder 1390.

The entropy encoder 1390 encodes various parameters and data into the bitstream 1395 by using entropy-coding techniques such as context-adaptive binary arithmetic coding (CABAC) or Huffman encoding. The entropy encoder 1390 encodes various header elements, flags, along with the quantized transform coefficients 1312, and the residual motion data as syntax elements into the bitstream 1395. The bitstream 1395 is in turn stored in a storage device or transmitted to a decoder over a communications medium such as a network.

The in-loop filter 1345 performs filtering or smoothing operations on the reconstructed pixel data 1317 to reduce the artifacts of coding, particularly at boundaries of pixel blocks. In some embodiments, the filtering or smoothing operations performed by the in-loop filter 1345 include deblock filter (DBF), sample adaptive offset (SAO), and/or adaptive loop filter (ALF). In some embodiments, luma mapping chroma scaling (LMCS) is performed before the loop filters.

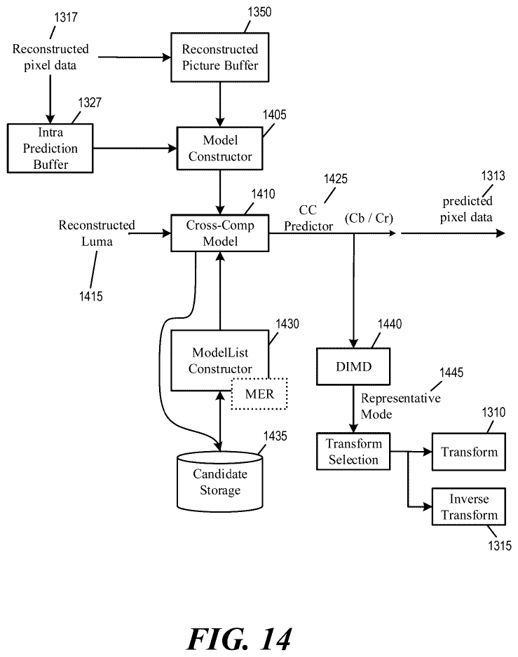

FIG. 14 illustrates portions of the video encoder 1300 that implement various features of cross-component prediction. The current block may be initially coded by inter-prediction, intra-prediction or IBC prediction (motion compensation module 1330 or intra prediction module 1325), which generate an initial predictor 1415. The initial predictor 1415 may be the luma component or one of the chroma component (e.g., Cb) of the predicted or reconstructed current block. A cross-component model 1410 is applied to the initial predictor 1415 to generate a cross-component predictor 1425 for the (remaining) chroma component (e.g., Cr). The samples of the the cross-component predictor 1425 (e.g., predicted chroma) may be included in the predicted pixel data 1313.

The cross-component model 1410 may be generated by a model constructor 1405 based on samples stored in the reconstructed picture buffer 1350 or the intra-prediction buffer 1327, which stores samples of the reconstructed pixel data 1317 taken before the in-loop filters 1345.

Section IV above describe several types of cross-component models that may be used as the cross-component model 1410. The cross-component model 1410 may also be selected from a candidate list (ModelList) that is provided by a ModelList constructor module 1430. ModelList is described in Section VIII.

A CCM storage 1435 stores cross component model (CCM) information for different pictures, including cross-component models generated by the model constructor 1405. The stored CCM information are made available to be inherited by subsequent blocks as candidates of ModelList.

For each block being currently encoded, the candidate list constructor module 1430 generates a corresponding ModelList from which the encoder may select a candidate to obtain a cross-component model to apply to the current block. In some embodiments, the ModelList constructor 1430 uses a predefined CCMER to limit the ModelList to exclude candidates from inside the CCMER, and to ensure that blocks within a same CCMER to share a same ModelList (or part of the same ModelList) or to derive their respective candidate lists independently. In some embodiments, the ModelList constructor 1430 allows the current block to inherit a cross-component model from a block that is coded by a different prediction mode (e.g., inter coded vs. intra coded) than the current block. In some embodiments, the ModelList constructor 1430 disallows such inheritance.

In some embodiments, a DIMD module 1440 performs texture analysis of the CC predictor 1425 to identify a representative mode 1445 for the current block, and the identified representative mode is used as an intra prediction mode to select primary and/or secondary transform type (as described in Section III) for the transform module 1310 and inverse transform module 1315.

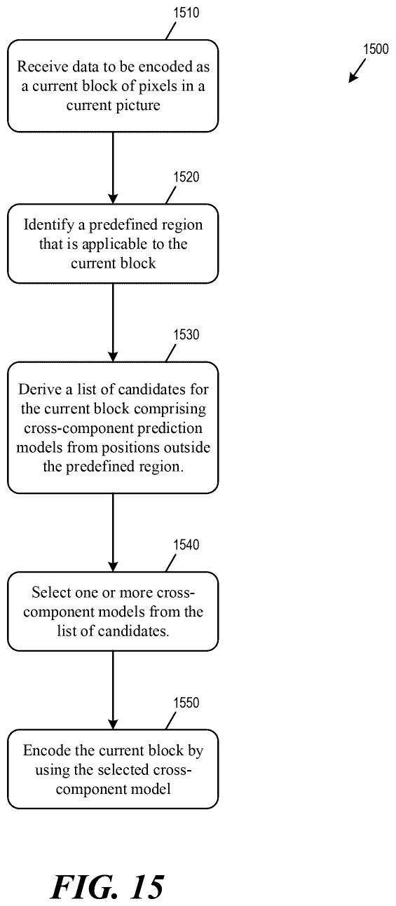

FIG. 15 conceptually illustrates a process 1500 for using cross-component prediction to encode a pixel block. In some embodiments, one or more processing units (e.g., a processor) of a computing device implementing the encoder 1300 performs the process 1500 by executing instructions stored in a computer readable medium. In some embodiments, an electronic apparatus implementing the encoder 1300 performs the process 1500.

The encoder receives (at block 1510) data to be encoded as a current block of pixels in a current picture. The current block may be inter-predicted by having a MV that references a reference block in a reference picture. The current block may be IBC predicted by having a BV that references a reference block in the current picture.

The encoder identifies (at block 1520) a predefined region (e.g., a CCMER) that is applicable to the current block. The encoder derives (at block 1530) a list of candidates that can be inherited by the current block, the list comprising cross-component prediction models from positions outside the predefined region. The predefined region may encompass the current block and another block that also uses the list of candidates (or part of the list of candidates) for cross-component prediction. In some embodiments, the another block uses at least one of spatial adjacent, spatial non-adjacent and history candidates from the list of candidates of the current block for cross-component prediction.

The predefined region may encompass first and second blocks, wherein a first candidate list derived for the first block excludes cross-component prediction information or model from the second block and a second candidate list derived for the second block excludes cross-component prediction information or model from the first block. Hence, the first candidate list and the second candidate list are independently derived.

In some embodiments, a history-based model candidate list is updated only if a size of the current block is larger than a threshold that is determined based on a size of the predefined region.

In some embodiments, a subsequent coded block that is coded by a different prediction mode than the current block is allowed to inherit the selected cross-component model, such that an intra coded or IBC-coded subsequent clock may inherit the cross-component model from an inter coded block. In some embodiments, a subsequent coded block that is coded by a different prediction mode than the current block is not allowed to inherit the selected cross-component model.

The encoder selects (at block 1540) one or more cross-component models from the list of candidates. The selection may be signaled by an index according to a reordering of the list.

The encoder encodes (at block 1550) the current block by using the selected one or more cross-component models to generate a prediction of the current block and to produce prediction residuals. The encoder may generate the prediction by applying the selected one or more cross-component models to a reconstructed or predicted first component (e.g., luma Y or chroma Cb) of the current block to generate a predictor for a second component (e.g., chroma Cb or chroma Cr) of the current block.

In some embodiments, the encoder identifies a representative prediction mode for the current block and uses the representative prediction mode to select at least one of a transform set (primary and secondary) and a transpose flag for transforming or inverse transforming the prediction residuals of the current block, wherein the current block is a chroma block. In some embodiments, the representative prediction mode is identified by performing texture gradient analysis (e.g., DIMD) of the predicted samples (or subsampling of the predicted samples) of the current block. In some embodiments, the representative prediction mode is identified by performing texture gradient analysis (e.g., DIMD) of the reconstructed samples (or subsampling of the reconstructed samples) of the current block. In some embodiments, the representative prediction mode is used if the current chroma block is referenced when deriving a set of most probable modes (MPM) for intra coding a subsequent block.

### X. Example Video Decoder

In some embodiments, an encoder may signal (or generate) one or more syntax element in a bitstream, such that a decoder may parse said one or more syntax element from the bitstream.

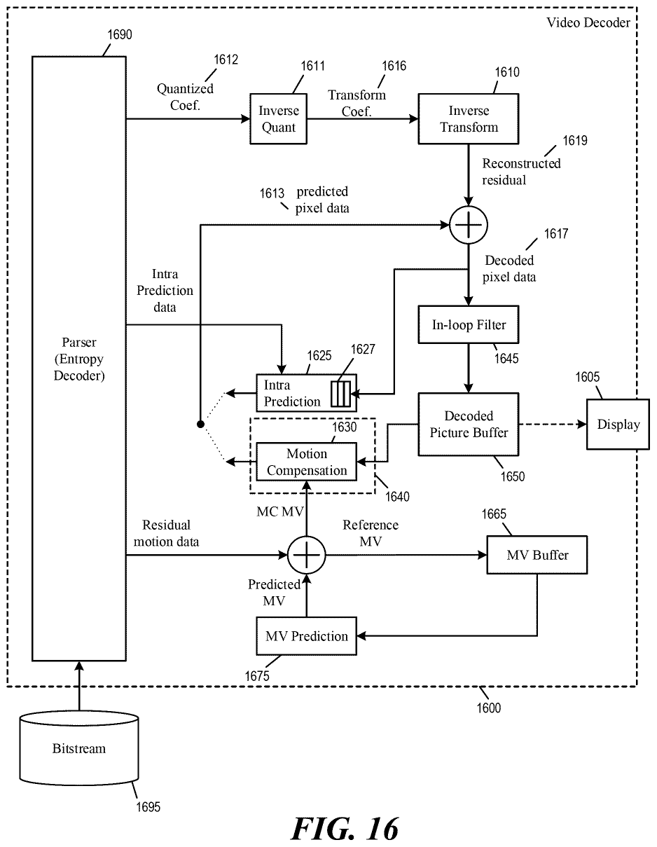

FIG. 16 illustrates an example video decoder 1600 that may implement cross component prediction. As illustrated, the video decoder 1600 is an image-decoding or video-decoding circuit that receives a bitstream 1695 and decodes the content of the bitstream into pixel data of video frames for display. The video decoder 1600 has several components or modules for decoding the bitstream 1695, including some components selected from an inverse quantization module 1611, an inverse transform module 1610, an intra-prediction module 1625, a motion compensation module 1630, an in-loop filter 1645, a decoded picture buffer 1650, a MV buffer 1665, a MV prediction module 1675, and a parser 1690. The motion compensation module 1630 is part of an inter-prediction module 1640.

In some embodiments, the modules 1610-1690 are modules of software instructions being executed by one or more processing units (e.g., a processor) of a computing device. In some embodiments, the modules 1610-1690 are modules of hardware circuits implemented by one or more ICs of an electronic apparatus. Though the modules 1610-1690 are illustrated as being separate modules, some of the modules can be combined into a single module.

The parser 1690 (or entropy decoder) receives the bitstream 1695 and performs initial parsing according to the syntax defined by a video-coding or image-coding standard. The parsed syntax element includes various header elements, flags, as well as quantized data (or quantized coefficients) 1612. The parser 1690 parses out the various syntax elements by using entropy-coding techniques such as context-adaptive binary arithmetic coding (CABAC) or Huffman encoding.

The inverse quantization module 1611 de-quantizes the quantized data (or quantized coefficients) 1612 to obtain transform coefficients, and the inverse transform module 1610 performs inverse transform on the transform coefficients 1616 to produce reconstructed residual signal 1619. The reconstructed residual signal 1619 is added with predicted pixel data 1613 from the intra-prediction module 1625 or the motion compensation module 1630 to produce decoded pixel data 1617. The decoded pixels data are filtered by the in-loop filter 1645 and stored in the decoded picture buffer 1650. In some embodiments, the decoded picture buffer 1650 is a storage external to the video decoder 1600. In some embodiments, the decoded picture buffer 1650 is a storage internal to the video decoder 1600.

The intra-prediction module 1625 receives intra-prediction data from bitstream 1695 and according to which, produces the predicted pixel data 1613 from the decoded pixel data 1617 stored in the decoded picture buffer 1650. In some embodiments, the decoded pixel data 1617 is also stored in a line buffer 1627 (or intra-prediction buffer) for intra-picture prediction and spatial MV prediction.

In some embodiments, the content of the decoded picture buffer 1650 is used for display. A display device 1605 either retrieves the content of the decoded picture buffer 1650 for display directly, or retrieves the content of the decoded picture buffer to a display buffer. In some embodiments, the display device receives pixel values from the decoded picture buffer 1650 through a pixel transport.

The motion compensation module 1630 produces predicted pixel data 1613 from the decoded pixel data 1617 stored in the decoded picture buffer 1650 according to motion compensation MVs (MC MVs). These motion compensation MVs are decoded by adding the residual motion data received from the bitstream 1695 with predicted MVs received from the MV prediction module 1675.

The MV prediction module 1675 generates the predicted MVs based on reference MVs that were generated for decoding previous video frames, e.g., the motion compensation MVs that were used to perform motion compensation. The MV prediction module 1675 retrieves the reference MVs of previous video frames from the MV buffer 1665. The video decoder 1600 stores the motion compensation MVs generated for decoding the current video frame in the MV buffer 1665 as reference MVs for producing predicted MVs.

The in-loop filter 1645 performs filtering or smoothing operations on the decoded pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF). In some embodiments, luma mapping chroma scaling (LMCS) is performed before the loop filters.

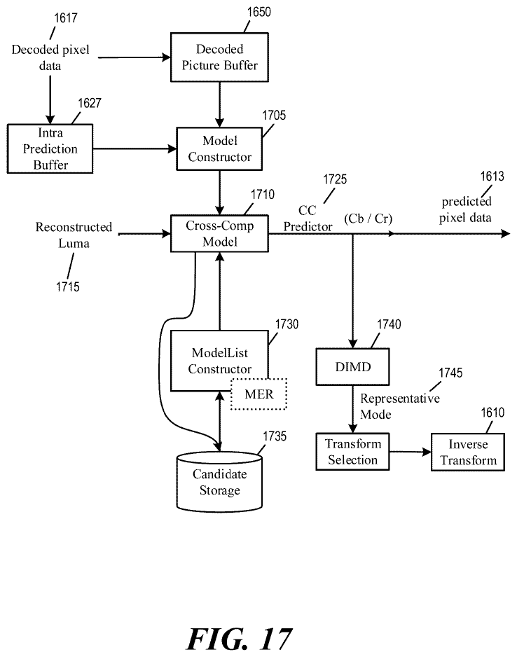

FIG. 17 illustrates portions of the video decoder 1600 that implement various features of cross-component prediction. The current block may be initially coded by inter-prediction, intra-prediction or IBC prediction (motion compensation module 1630 or intra prediction module 1625), which generate an initial predictor 1715. The initial predictor 1715 may be the luma component or one of the chroma component (e.g., Cb) of the predicted or reconstructed current block. A cross-component model 1710 is applied to the initial predictor 1715 to generate a cross-component predictor 1725 for the (remaining) chroma component (e.g., Cr). The samples of the cross-component predictor 1725 may be included in the predicted pixel data 1613.

The cross-component model 1710 may be generated by a model constructor 1705 based on samples stored in the decoded picture buffer 1650 and/or the intra-prediction buffer 1627, which stores samples of the decoded pixel data 1617 taken before the in-loop filters 1645.

Section IV above describe several types of cross-component models that may be used as the cross-component model 1710. The cross-component model 1710 may also be selected from a candidate list (ModelList) that is provided by a ModelList constructor module 1730. ModelList is described in Section VIII.

A CCM storage 1735 stores cross component model (CCM) information for different pictures, including cross-component models generated by the model constructor 1705. The stored CCM information are made available to be inherited by subsequent blocks as candidates of ModelList.

For each block being currently decoded, the candidate list constructor module 1730 generates a corresponding ModelList from which the decoder may select a candidate to obtain a cross-component model to apply to the current block. In some embodiments, the ModelList constructor 1730 uses a predefined CCMER to limit the ModelList to exclude candidates from inside the CCMER, and to ensure that blocks within a same CCMER to share a same ModelList (or part of the same ModelList) or to derive their respective candidate lists independently. In some embodiments, the ModelList constructor 1730 allows the current block to inherit a cross-component model from a block that is coded by a different prediction mode (e.g., inter coded vs. intra coded) than the current block. In some embodiments, the ModelList constructor 1730 disallows such inheritance.

In some embodiments, a DIMD module 1740 performs texture analysis of the CC predictor 1725 to identify a representative mode 1745 for the current block, and the identified representative mode is used as an intra prediction mode to select primary and/or secondary transform type (as described in Section III) for the inverse transform module 1610.

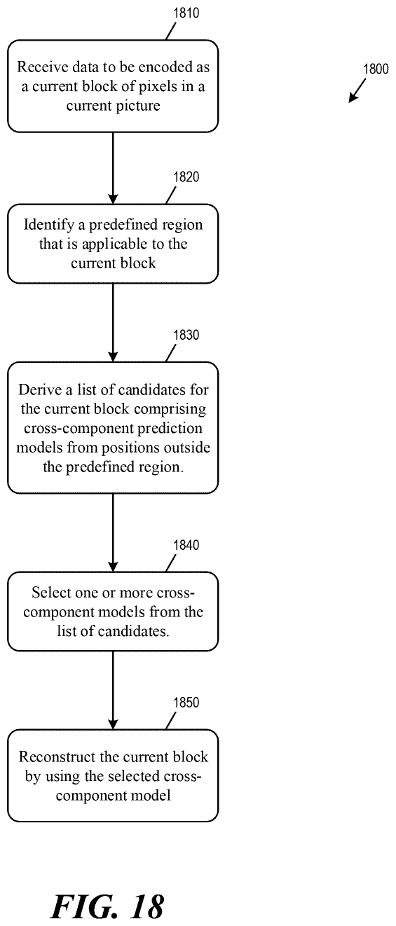

FIG. 18 conceptually illustrates a process 1800 for using cross-component prediction to decode a pixel block. In some embodiments, one or more processing units (e.g., a processor) of a computing device implementing the decoder 1600 performs the process 1800 by executing instructions stored in a computer readable medium. In some embodiments, an electronic apparatus implementing the decoder 1600 performs the process 1800.

The decoder receives (at block 1810) data to be decoded as a current block of pixels in a current picture. The current block may be inter-predicted by having a MV that references a reference block in a reference picture. The current block may be IBC predicted by having a BV that references a reference block in the current picture.

The decoder identifies (at block 1820) a predefined region (e.g., a CCMER) that is applicable to the current block. The decoder derives (at block 1830) a list of candidates that can be inherited by the current block, the list comprising cross-component prediction models from positions outside the predefined region. The predefined region may encompass the current block and another block that also uses the list of candidates (or part of the list of candidates) for cross-component prediction. In some embodiments, the another block uses at least one of spatial adjacent, spatial non-adjacent and history candidates from the list of candidates of the current block.

The predefined region may encompass first and second blocks, wherein a first candidate list derived for the first block excludes cross-component prediction information or model from the second block and a second candidate list derived for the second block excludes cross-component prediction information or model from the first block. Hence, the first candidate list and the second candidate list are independently derived. Hence, the first candidate list and the second candidate list are independently derived.

In some embodiments, a history-based model candidate list is updated only if a size of the current block is larger than a threshold that is determined based on a size of the predefined region.

In some embodiments, a subsequent coded block that is coded by a different prediction mode than the current block is allowed to inherit the selected cross-component model, such that an intra coded or IBC-coded subsequent clock may inherit the cross-component model from an inter coded block. In some embodiments, a subsequent coded block that is coded by a different prediction mode than the current block is not allowed to inherit the selected cross-component model.

The decoder selects (at block 1840) one or more cross-component models from the list of candidates. The selection may be signaled by an index according to a reordering of the list.

The decoder reconstructs (at block 1850) the current block by using the selected one or more cross-component models to generate a prediction of the current block. The decoder may then provide the reconstructed current block for display as part of the reconstructed current picture. The decoder may generate the prediction by applying the selected one or more cross-component models to a reconstructed or predicted first component (e.g., luma Y or chroma Cb) of the current block to generate a predictor for a second component (e.g., chroma Cb or chroma Cr) of the current block.

In some embodiments, the decoder identifies a representative prediction mode for the current block and uses the representative prediction mode to select at least one of a transform set (primary and secondary) and a transpose flag for inverse transforming the prediction residuals of the current block, wherein the current block is a current chroma block. In some embodiments, the representative prediction mode is identified by performing texture gradient analysis (e.g., DIMD) of the predicted samples (or subsampling of the predicted samples) of the current block. In some embodiments, the representative prediction mode is identified by performing texture gradient analysis (e.g., DIMD) of the reconstructed samples (or subsampling of the reconstructed samples) of the current block. In some embodiments, the representative prediction mode is used if the current chroma block is referenced when deriving a set of most probable modes (MPM) for intra coding a subsequent block.

### XI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

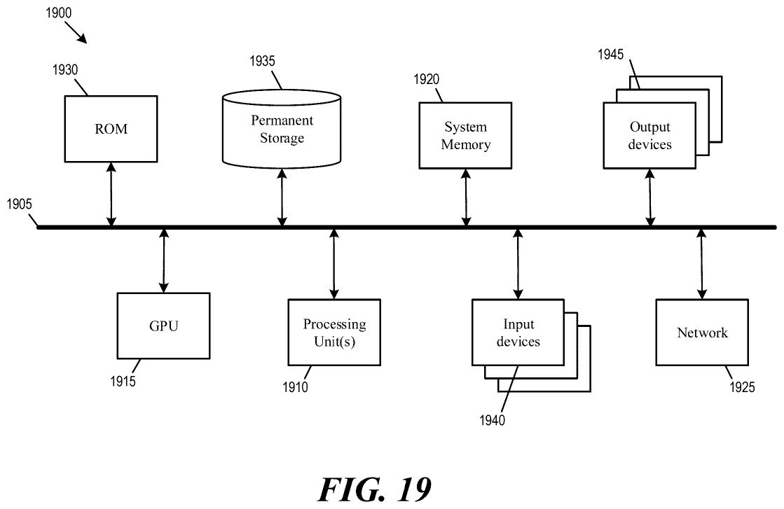

FIG. 19 conceptually illustrates an electronic system 1900 with which some embodiments of the present disclosure are implemented. The electronic system 1900 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1900 includes a bus 1905, processing unit(s) 1910, a graphics-processing unit (GPU) 1915, a system memory 1920, a network 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the GPU 1915, the read-only memory 1930, the system memory 1920, and the permanent storage device 1935.

From these various memory units, the processing unit(s) 1910 retrieves instructions to execute and data to process in order to execute the processes of the present disclosure. The processing unit(s) may be a single processor or a multi-core processor in different embodiments. Some instructions are passed to and executed by the GPU 1915. The GPU 1915 can offload various computations or complement the image processing provided by the processing unit(s) 1910.

The read-only-memory (ROM) 1930 stores static data and instructions that are used by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the present disclosure use a mass-storage device (such as a magnetic or optical disk and its corresponding disk drive) as the permanent storage device 1935.

Other embodiments use a removable storage device (such as a floppy disk, flash memory device, etc., and its corresponding disk drive) as the permanent storage device. Like the permanent storage device 1935, the system memory 1920 is a read-and-write memory device. However, unlike storage device 1935, the system memory 1920 is a volatile read-and-write memory, such a random access memory. The system memory 1920 stores some of the instructions and data that the processor uses at runtime. In some embodiments, processes in accordance with the present disclosure are stored in the system memory 1920, the permanent storage device 1935, and/or the read-only memory 1930. For example, the various memory units include instructions for processing multimedia clips in accordance with some embodiments. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1925 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 15 and FIG. 18) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
identifying a predefined region that is applicable to the current block;
deriving a list of candidates that can be inherited by the current block, the list comprising cross-component prediction models from positions outside the predefined region;
selecting one or more cross-component models from the list of candidates; and
encoding or decoding the current block by using the selected one or more cross-component models.

2. The video coding method of claim 1, wherein encoding or decoding the current block comprises applying the selected cross-component model to reconstructed or predicted first component of the current block to generate a predictor for a second component of the current block.

3. The video coding method of claim 2, wherein the first component is the luma component and the second component is a chroma component.

4. The video coding method of claim 2, wherein the first and second components are two different chroma components.

5. The video coding method of claim 1, wherein the current block is inter-predicted or IBC-predicted.

6. The video coding method of claim 1, wherein a subsequent coded block that is coded by a different prediction mode than the current block is allowed to inherit the selected cross-component model.

7. The video coding method of claim 1, wherein a subsequent coded block that is coded by a different prediction mode than the current block is not allowed to inherit the selected cross-component model.

8. The video coding method of claim 1, wherein the predefined region encompasses first and second blocks, wherein a first candidate list derived for the first block excludes cross-component prediction information from the second block and a second candidate list derived for the second block excludes cross-component prediction information from the first block.

9. The video coding method of claim 8, wherein the first candidate list and the second candidate list are independently derived.

10. The video coding method of claim 1, wherein the predefined region encompasses the current block and another block that also uses all or part of the list of candidates for cross-component prediction.

11. The video coding method of claim 10, wherein the another block uses at least one of spatial adjacent, spatial non-adjacent and history candidates from the list of candidates of the current block.

12. The video coding method of claim 1, wherein a history-based model candidate list is updated only if a size of the current block is larger than a threshold that is determined based on a size of the predefined region.

13. A video coding method comprising:
receiving data to be encoded or decoded as a current block of pixels of a current picture of a video;
deriving a list of candidates that can be inherited by the current block based on the prediction residuals of the current block;
selecting one or more cross-component models from the list of candidates;
identifying a representative prediction mode for the current block and using the representative prediction mode to select at least one of a transform set and a transpose flag for transforming or inverse transforming prediction residuals of the current block, wherein the current block is a current chroma block; and
encoding or decoding the current block by using the selected one or more cross-component models.

14. The video coding method of claim 13, wherein the representative prediction mode is identified by performing texture gradient analysis of predicted chroma samples of the current block.

15. The video coding method of claim 13, wherein the representative prediction mode is used if the current chroma block is referenced when deriving a set of most probable modes (MPM) for intra coding a subsequent block.

16. An electronic apparatus comprising:
a video coder circuit configured to perform operations comprising:
receiving data to be encoded or decoded as a current block of pixels of a current picture of a video;
identifying a predefined region that is applicable to the current block;
deriving a list of candidates that can be inherited by the current block, the list comprising cross-component prediction models from positions outside the predefined region;
selecting one or more cross-component models from the list of candidates; and
encoding or decoding the current block by using the selected one or more cross-component models.

17. A video decoding method comprising:
receiving data to be decoded as a current block of pixels of a current picture of a video;
identifying a predefined region that is applicable to the current block;
deriving a list of candidates that can be inherited by the current block, the list comprising cross-component prediction models from positions outside the predefined region;
selecting one or more cross-component models from the list of candidates; and
reconstructing the current block by using the selected one or more cross-component models.

18. A video encoding method comprising:
receiving data to be encoded as a current block of pixels of a current picture of a video;
identifying a predefined region that is applicable to the current block;
deriving a list of candidates that can be inherited by the current block, the list comprising cross-component prediction models from positions outside the predefined region;
selecting one or more cross-component models from the list of candidates; and
encoding the current block by using the selected one or more cross-component models.
